(19) United States
(12) Patent Application Publication
(10) Pub. No.: US 2023/0288173 A1
(43) Pub. Date: Sep. 14, 2023

(54) COMPOSITE STRUCTURES FOR ENERGY DISSIPATION AND METHOD

(71) Applicant: The Regents of the University of California, Oakland, CA (US)

(72) Inventors: David Kisailus, Riverside, CA (US); Wei Huang, Riverside, CA (US)

(21) Appl. No.: 18/016,435

(22) PCT Filed: Jul. 16, 2021
(86) PCT No.: PCT/US2021/042024

§ 371 Date: Jan. 16, 2023

Related U.S. Application Data
(60) Provisional application No. 62/705,821, filed on Jul. 16, 2020.

(51) Int. Cl. F41H 5/04

(52) U.S. Cl. CPC F41H 5/0492; B29C 71/02

(57) ABSTRACT

Described herein are composite materials that can include a stiff phase and a compliant phase where the stiff phase forms an interpenetrating network within the compliant phase, the interpenetrating network can be described as bi-continuous phase, such as a gyroid phase. Also described are methods of making these materials.

### CLAIM OF PRIORITY

This patent application claims the benefit of priority to U.S. Provisional Patent Application Ser. No. 62/705,821, entitled “Composite Structures for Energy Dissipation and Method,” filed on Jul. 16, 2020, which is hereby incorporated by reference herein in its entirety.

### GOVERNMENT INTEREST

Some examples disclosed herein were made with government support under Contract No. FA9550-15-1-0009 awarded by the United States Air Force of Scientific Research. The Government has certain rights.

### TECHNICAL FIELD

Embodiments described herein generally relate to composite structures for energy dissipation and methods. A rigid, reinforced composite structure useful in energy dissipation such as absorbing high strain impacts. Also described are apparatuses that comprise the structure, for example: protective armor, sports protective equipment, crash protection devices.

### BACKGROUND

Currently in the field, coatings are applied to surfaces to reduce damage through adding one or more extra layers of protection. Some surfaces can wear easily. Additionally, some coatings do not protect well against high impact forces. Other materials that are inherently susceptible to failure at high stresses, such a tempered glass, are designed for failure by being cooled quickly at their surfaces to induce an inherent compressive strain, where the fractured components are more isotropic, rather than long needle or shard like form, thus protecting the individual from a ballistic spray of potentially deadly projectiles. In many of these coatings, the energy from an impact is not absorbed very easily and translated back to the impacting projectile. This can be a problem if the projectile is needed to be protected, for example, a human head impacting the surface of a car. In such a scenario, the damage sustained from the impact would be mitigated by the human head, rather than be absorbed by the automobile, possibly resulting in traumatic injury. Some solutions include inorganic particle-based coatings dispersed in a matrix that undergo translation or rotation to reduce these stresses. However, in the case of high strain rate impacts, additional damping and energy absorption are always useful. Enhanced damping properties are required, which are important to dissipate large amounts of impact energy. Thus, there is a need for materials with unique architectures that can absorb significant amounts of energy from high strain rate impacts. With the proper material and architectural design, these materials could be used in coatings and many other applications.

### BRIEF DESCRIPTION OF THE DRAWINGS

FIG. 1 is a figure showing: (A-C) the natural analog mantis shrimp nanoparticles on the impact surface of the mantis shrimp dactyl club; (D-E) high resolution micrograph showing protein and chitin organic phases interpenetrated with a hydroxyapatite network; (F) the inorganic network after high temperature treatment, indicating intact and porous framework of the hydroxyapatite phase according to one example.

FIG. 2. is a figure depicting mechanical properties of bi-continuous nanoparticles, (A) is an Ashby plot of the loss coefficient versus Young's modulus. It was observed that the particles on the impact surface have significantly higher damping properties than metals and ceramics, and also maintains stiffness. (B) shows large amount of deformation of particles under quasi-static compression, indicating large amount of energy dissipation.

FIG. 3. shows the energy dissipation mechanisms of the bi-continuous particles. (A, B) show particle breakage and fiber bridging after high strain rate impacts. (C, D) high resolution micrographs show dislocations and amorphization induced by impacts.

FIG. 4. depicts several pictures showing the natural analog's ability to deform and recover under quasi-static testing, (A) initial deformation, (B) severely deformed structure, and (C) its ability to recover when the load is removed.

FIG. 5. is a figure showing a non-limiting example of a composite material embodiment. 100, in particle form, 200, deposited on a backing layer, 300, where the material comprises of a stiff phase, 101 and a compliant phase, 102.

FIG. 6. is a figure showing a non-limiting example of a composite material embodiment, 100, in layer form, 400, deposited on a backing layer, 300, where the material comprises of a stiff phase, 101 and a compliant phase, 102.

FIG. 7. is a diagram showing a non-limiting embodiment for making the composite materials via 3-dimensional assembly methods.

FIG. 8. is a schematic showing a non-limiting embodiment for making the composite materials via polymeric template methods. Dashed boxes indicate optional steps.

FIG. 9. is a figure showing yet another non-limiting method embodiment for making the composite materials via blending with partially miscible materials.

FIG. 10. shows impact surface of the dactyl club of the mantis shrimp. (a) Photograph of a mantis shrimp and its dactyl club, indicated with white arrows. Optical micrographs of transverse sections of an intact, inter-molted dactyl club (b) and a damaged molted club (c). In (b) and (c), the impact surface, impact region and periodic region are depicted. Insets of (b) and (c): differential interference contrast (DIC) images, highlighting the intact (b) and worn (c) surfaces of the clubs. (d) SEM micrograph of a transverse section of an inter-molted dactyl club. Nanoparticles (inset) ˜60 nm in diameter are found within the impact surface. (e) TEM micrograph of the nanoparticles confirm the size and volume fraction of particles in the impact surface (˜88%). Inset: SAED indicating the nanoparticles consist, in part, of hydroxyapatite. (f) AFM indentation depth maps overlaid on 3D topographical maps of the nanoparticles from the red boxed region in figure d. Inset: a higher resolution AFM indentation map reveals the ˜60 nm particles are composed of smaller grains. (g) Schematic of the dactyl club, highlighting the impact surface and illustrating its location and hierarchical nature. From left to right: drawing of the dactyl club, with the transverse cutaway highlighted in color; impact surface and impact region from the transverse section; hydroxyapatite nanoparticles embedded in an organic matrix on the impact surface; bi-continuous network of the HAP nanoparticles within an organic phase.

FIG. 11. shows nano-architectural design features of particles within the impact surface of the dactyl club. (a) Primary grains are found assembled within a single ˜60 nm secondary particle. The arcs in the FFT pattern indicate the misalignment of primary grains in the larger, secondary particle. Red arrows shows the white dots inside the primary grain, suggesting a second phase. (b) Grain boundaries and misalignment of adjacent grains, indicated by FFT. Inset: HRTEM micrograph demonstrating the disordered grain boundary adjacent to highly ordered atoms in the (100) planes of HAP crystals. The second phase found in (a) is outlined in green. (c) Misalignment (˜1.5°) of two adjacent grains. (d) AFM phase map of coronal section of impact surface, showing the network of two different phases. Inset: high resolution image illustrating the existence of a network of two different phase in a single particle. (e) HRTEM image shows the organic network within the HAP crystalline network. Green dashed lines indicate areas that have organic phase, suggested from the expanded d-spacings of the lattice. (f) HRTEM micrograph of (002) planes within a single secondary particle. The areas of lighter contrast are marked with yellow ellipses to highlight regions containing organic, with distorted crystal planes. The inset yellow box shows a higher magnification of the distorted lattice. Scale bar is 2 nm. (g) HRTEM of uranyl acetate and lead citrate stained samples, showing the chitin molecules surrounding the HAP crystal lattice. Proteins are stained in dark spots. Inset: FFT of the chitin wrapped HAP nanoparticles. Diffraction spots represent HAP crystals, while the broad diffuse ring represents the chitin macromolecules. (h) SEM of HAP particles after heat treatment in air at 800° C. (i) HRTEM of a single HAP particle from (h). The hydroxyapatite inorganic network is revealed. (j) HRTEM of (100) HAP crystal planes. No lattice distortion is observed (as compared to particles in (e) and (f). (k) Schematics of the bi-continuous structure of the hydroxyapatite-based nanoparticle and oriented attachment of HAP nanocrystals, in which lattice mismatch and organics embedded within the HAP crystal lattice are illustrated.

FIG. 12. shows effects of high strain-rate micro-impact tests, damping behavior and energy dissipation of the impact surface of the dactyl club. (a) Schematic highlighting the regions interrogated by the impact tests: the impact surface (top) and impact region (bottom) of the dactyl club. (b-g) SEM micrographs of damaged surfaces after micro-impacts: Impact from a blunt spherical indenter head on the impact surface (b) and the impact region (c). Surfaces after multiple (i.e., 100) impacts on the impact surface (d) and the impact region (e). Impact damage areas from a sharp cube corner indenter head on the impact surface (f) and the impact region (g). Rᵢ is the indentation area, and R_{d} is the actual damaged area on the indentation surface. (h) Plots of penetration depth vs. number of impacts during the multiple impact tests. The inset table shows impact depth as a function of impact load on both the impact surface and the impact region for the initial impact. (i) Relationship of damage area vs. penetration depth of various engineering and biological materials subjected to high strain rate impact. Under the same impact conditions, the impact surface of the dactyl club shows the smallest penetration depth and damage area. (j) Plot of storage modulus and tan δ as a function of dynamic frequency (acquired from nanoDMA testing) for both impact surface and impact region.

FIG. 13. shows Ashby plot of loss coefficient and Young's modulus of synthetic and natural materials. Loss coefficient and Young's modulus data of dactyl clubs acquired from nanoindentation and nanoDMA are incorporated into the plot. Inset: loss coefficient data overlaid on a 3D topographical map of the impact surface acquired from AFM, highlighting the tan S distribution in HAP and organic phases at the nanoscale.

FIG. 14. shows nanoscale energy dissipation mechanisms of the impact surface of the dactyl club. (a) Region of contact (coronal plane) for the quasi-static indentation and micro-impact tests. The optical micrograph (bottom) highlighting the damaged areas. (b) SEM micrograph of the transverse section of the damaged area after high strain rate impact. Inset (red box): surface of impact indicating both large ˜60 nm and small ˜10-20 nm nanoparticles. (c) TEM micrograph in the damaged area (red box from figure b) confirming the presence of ˜10-20 nm nanoparticles. Analysis of the SAED pattern reveals randomly oriented nanocrystals, formed from the fracture of mesocrystalline particles upon high strain rate impact (Figure if). (d-e) HRTEM micrograph illustrating the modification of the ordered grains before impact (d) via rotation and translation under high strain rate impact (e). (t) Dislocations induced by impact. (g) Higher magnification of dislocations within (211) planes. Comparison between perfect (h) and impact-induced amorphization (i) in (211) planes. (j) Load vs. displacement curves of in-situ TEM compression of a single nanoparticle. Black, red and blue curves show three continuous loading cycles of a single particle. Particle fracture is indicated with black arrows. (k) Schematic and summary of nanoscale toughening mechanisms of impact surface composite nanoparticles from high strain rate impacts.

FIG. 15. shows molecular dynamic simulations of the energy dissipation in the bi-continuous HAP nanoparticles. (a) Schematic of the bi-continuous nanoparticles. (b) AFM mapping and MD models of the bi-continuous structure at the nanoscale. Blue and red colors indicate HAP and organic phase, respectively. (c) Regions of highly oriented, mesocrystalline particles at the edge of the HAP network are shaded in pink. FFT of a single particle from the left HRTEM is shown. The arc marked with yellow lines shows the misalignment of the primary particles shown in the pink region. The angle that the arc covers is ˜12.7. (d) MD model showing the grain boundary between two adjacent HAP single crystals. (e) MD simulation results of the stress-strain curves of the bi-continuous models, showing a strain-rate dependent behavior. Localized breakage of HAP phase occurs at low strain rate compression (top, right), while uniformly distributed strain is observed at high strain rate impacts (bottom, right). (f) Strength and toughness as a function of grain boundary angle.

FIG. 16. shows TEM and HRTEM micrographs of hydroxyapatite (HAP) composite nanoparticles within the impact surface. (a) Secondary HAP nanoparticles marked with red outlines. The yellow dashed lines show the alignment of primary particles within a single secondary HAP particle. (b) SAED pattern from the TEM image in (a). The small arcs indicate slight mis-alignments of nanocrystals within the secondary particle. (c) HRTEM image of a single HAP particle, with brighter contrast regions suggesting the presence of a secondary phase. (d) FFT of the particle in (c). (e) HRTEM of the (100) lattice in the HAP nanocrystals. Insets: Stacking faults are observed within primary particles.

FIG. 17. shows FTIR and TGA characterization of nanoparticles on the impact surface. (a) FTIR spectrum of the nanoparticles on the impact surface, indicating the existence of hydroxyapatite, chitin and protein. (b) TGA/DSC curves of the HAP nanoparticles. The weight percentage of the organics, including chitin and protein, is ˜12 (c) Optical micrograph of demineralized dactyl club. The white dots represent different regions where FTIR spectra were acquired. (d) FTIR spectra from regions indicated by the white dots in (c). Amide I. amide IT and C—O stretching peaks are indicated in the spectrum 1 and 2, showing the existence of chitin. The amide I and II bands shift to a lower wavenumber compared with chitin amide bands (amide I 1630˜1660 cm⁻¹, amide II ˜1558 cm⁻¹), which are more characteristic of proteins.

FIG. 18. shows (a) HRTEM of HAP nanoparticles on the impact surface after staining with uranyl acetate and lead citrate. The HAP continuous network is revealed. The darker regions are proteins revealed from staining. (b) HRTEM of HAP nanoparticles after TGA. The HAP continuous network is similar to particles before heat treatment. (c) XRD of particles scratched from the impact surface and impact region. The broader diffraction peaks from the native sample (before TGA) narrowed due to grain growth during annealing. HAP appears stable, with no secondary phase formation, even after heating to 800° C. in air.

FIG. 19. shows HRTEM of uranyl acetate and lead citrate stained HAP nanoparticles on the impact surface. The reduced ordering in protein complexes provide a higher permeability for the heavy metal staining solution, resulting in greater contrast in the TEM micrograph. (a) HRTEM of a HAP nanoparticle, showing chitin macromolecules wrapping around the HAP crystal. (b) FFT of the HAP crystal lattice indicated with a purple box in (a). Both diffraction spots and rings are observed in the FFT pattern. Inverse Fast Fourier Transform (IFFT) is performed on the diffraction spots and rings, separately. The yellow box (upper, right inset) shows the HAP lattice after IFFT, while red box (lower, left) shows the location of chitin macromolecules. (c) HRTEM of a HAP nanoparticle. (d) FFT of the HAP nanoparticle in (c). The (201) reflection from HAP is indicated with a yellow arrow, whereas the (003) planes of chitin (diffraction ring) are highlighted by the green arrow. (e, f) HRTEM showing the interface between chitin macromolecules and a HAP nanocrystal. The (201) crystal planes of HAP appear adjacent with (003) planes of chitin, suggesting a potential epitaxial growth of HAP on chitin macromolecules.

FIG. 20. shows TEM and AFM images highlighting the bi-continuous network of inorganic and organic phases. The yellow circles in the top two HRTEM images (a) highlight the organic networks, which shows a lower contrast in TEM. (b) AFM images at the bottom are indentation depth maps. The indentation depth is larger in the area where organics are present because of a lower stiffness. Thus, the blue areas are organic, while the red color represents the hydroxyapatite network. (c) AFM mapping of tan S of the nanoparticles. (d) Distribution of the values of tan S in the nanoparticle.

FIG. 21 a-d. shows NanoDMA of impact surface and impact regions. Storage modulus and tan δ were acquired as a function of frequency (9-100 Hz). The large variations of modulus and tan S in the impact region are due to the different fiber orientations.

FIG. 22. shows (a) Velocity of the indenter head as a function of time during micro-impact tests. The time frame of the impact velocity decreasing from its peak value to zero on the impact surface is ˜50 ms, which is much larger than that in Al (˜12 ms) and fused silica (˜8 ms), indicating better damping properties in the impact region and impact surface. (b) Plots of deceleration as a function of time during the impact tests in the impact region and impact surface. Single crystal Al and fused silica are tested for comparison. The deceleration in both the impact surface and the impact region are larger than in those in Al and fused silica, indicating a more significant damping behavior in the dactyl club.

FIG. 23. shows strain-rate dependent behavior in the impact surface of dactyl club. Load-displacement curves of quasi-static nanoindentation on the impact surface with a sharp cube corner (a) and a blunt spherical indenter head (b). (c) Comparison of penetration depth and applied energy between quasi-static nanoindentation and impact tests. (d-g) SEM micrographs of the damage modes in quasi-static nanoindentation and impacts with sharp and blunt indenter heads. (h) SEM images showing particle pile up and crack initiation and propagation. (i) and (j) TEM images of HAP nanoparticles after indentation. The secondary HAP particles remain intact after quasi-static nanoindentation.

FIG. 24. shows SEM and TEM images of damage within the impact surface after a single high strain rate micro-impact. (a) SEM images of the damage area after impact tests. The inset image shows particle size ˜10-20 nm, indicating particle breakages after impacts. (b) SEM image of the transverse section of the impact location. No obvious damage or cracks are observed underneath the impact area. (c) and (d) TEM images indicating the large secondary particles are broken into ˜10-20 nm primary particles after high strain rate impacts. (e) Damage at different depths from the surface. The particle breakage is limited to ˜100-200 nm depth from the impact surface. The particle breakage area is indicated with a yellow dashed line. Dislocation and amorphization are found in the red and blue boxed areas, but not in the purple area, indicating impact induced dislocation and amorphization is limited to ˜1000 nm depth from the surface.

FIG. 25. shows In-situ compression tests of single HAP nanoparticles. (a-d) HAP nanoparticle before and after compression tests, indicating particle breakage. (e) Load vs. displacement curves of different tests. The breakage of particles and energy dissipation events are marked with back arrows. The total energy dissipation during compression is calculated from the integration of the force-displacement curves.

FIG. 26. shows plot of temperature as a function of strain, indicating thermal stability (i.e., maintained at approximately room temperature. 300 K) when loaded at different strain rates.

FIG. 27. shows MD simulation of shock induced amorphization in HAP crystals. (a) MD models of shock wave along [001]direction of HAP crystals. White dots indicate amorphization areas. (b) Amorphization work as a function of longitudinal shock stress. The impact stress in the current impact tests is ˜0.98 GPa, leading to a ˜0.038 GJ/m³ amorphization work. z represents shear stress, p is the hydrostatic pressure.

### DESCRIPTION OF EMBODIMENTS

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Nature utilizes available resources to construct lightweight, strong and tough materials under constrained environmental conditions. The impact surface of the fast-striking dactyl club from the mantis shrimp is an example of one such composite that evolved the capability to localize damage and avoid catastrophic failure from high-speed collisions during its feeding activities. This well-architected composite coating is constructed during an intermolt phase using controlled crystallization to yield a surface consisting of densely packed (˜88 vol %)˜65 nm bi-continuous nanoparticles of hydroxyapatite (HAP) integrated within an organic matrix. The mineral within these bi-continuous particles is mesocrystalline, assembled from small (˜10-20 nm), highly aligned nanocrystals. Under high strain rate (˜10⁴ s⁻¹) impacts, particles rotate and translate, while the nanocrystalline networks fracture at low angle grain boundaries, form dislocations, and undergo amorphization. The interpenetrating organic network also provides additional toughening, with ˜80% deformation occurring under quasi-static loading, as well as significant damping, with loss coefficient ˜0.02. A rare combination of stiffness and damping is therefore achieved, outperforming many engineered materials.

There is an urgent need for light weight, high-performance impact resistant and energy absorbent materials in many facets of our society including automobile and aerospace engineering. Over the past few decades, natural systems have proven an incredible resource for discovery of new material designs with broad application. This includes implementation towards synthetic impact-resistant materials. To this end, organisms build these natural composites to ensure their survival against a variety of stresses; this requires clever designs under the constraints of both limited material selection and a narrow range of synthesis conditions. One key consideration into the design of these natural-based constructs is the effect of strain rate. For example, bones in the human body are generally placed under quasi-static and fatigue loading, while deer antlers with similar material components face significantly higher strain rate (˜10³ s⁻¹) impacts. Indeed, the antlers are able to endure multiple collisions due to a lower mineral content and a modified design, which leads to an order of magnitude higher energy absorption under impact versus that of human cortical bone. This observation provides insight into the adaptability of structural materials within biological systems to the environmental stresses over millions of years of evolution.

One example of a very well-studied natural composite is the highly mineralized nacreous layer of the abalone shell, which has demonstrated remarkable mechanical strength and toughness to resist penetration damage from predators while maintaining structural integrity. These mollusk shells are strong and tough biological armor (up to 40×tougher than its ceramic constituent), yet they can still be fractured through high strain rate impacts from the strikes of a mantis shrimp, Odontodactylus scyllarus. Using its dactyl club, a highly developed hammer-like raptorial appendage, this powerful crustacean can generate up to 1500 N of force by accelerating the club at over ˜10 000 g (a football player can get a concussion at 98 g) and speeds of 23 m/s, well beyond the limit that the hard mollusk shell can withstand. At the same time, this feeding behavior, as well as other daily activities such as ritualized fighting and dwelling construction, necessitates a sufficient amount of energy dissipation within the dactyl club to maintain structural integrity for thousands of future impacts. The multiregional and hierarchical composite structure, as well as damage mitigation mechanisms of the dactyl club from the smashing type of mantis shrimp, have been studied intensively in recent years. These studies revealed that a helicoidal arrangement of mineralized alpha-chitin fibers combined with a herringbone architecture resulting from a mineralization gradient, can deflect and twist crack propagation, thus increasing the overall toughness of the clubs. Although the aforementioned studies provide insights to mechanisms of toughening in the club, effects of multiple high strain rate impacts, similar to those encountered in the native environment of the mantis shrimp, are still not known and would be of great interest for multiple engineering applications.

Here, we reveal the effects of high strain rate, microscale impacts on these biological hammers, specifically an ultrathin (˜70 μm) nanoparticle-based coating that protects the underlying fiber-based composite structure from massive contact stresses. Specifically, we uncover the hierarchical nature of these nanoparticles, demonstrating that the impact penetration depth is reduced by at least 50%, and revealing multiscale energy dissipation mechanisms that help to mitigate catastrophic failure. Damage localization is a key factor protecting this highly mineralized structure from crack initiation and propagation under high strain-rate (˜10⁴ s⁻¹) impacts. In addition, significant damping (loss coefficient ˜0.02) while maintaining high stiffness (Elastic modulus ˜58.9 GPa) is also observed, a rare combination not common in engineered materials. These findings provide insight towards protecting a broad variety of structures from multiple high-speed impact events that will ultimately prevent catastrophic failure and more importantly, personal injury.

### Nanoparticle Based Coating on the Surface of Dactyl Club

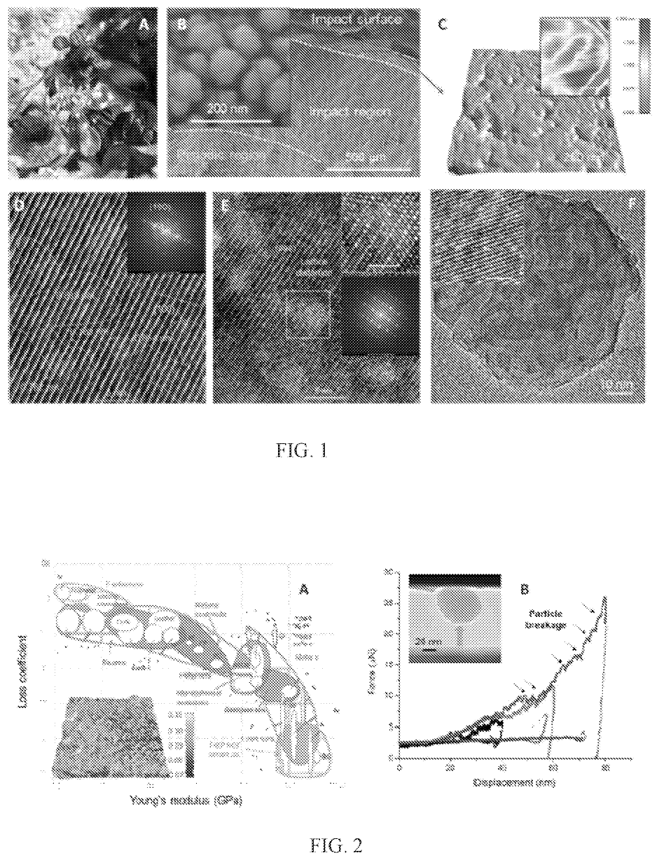

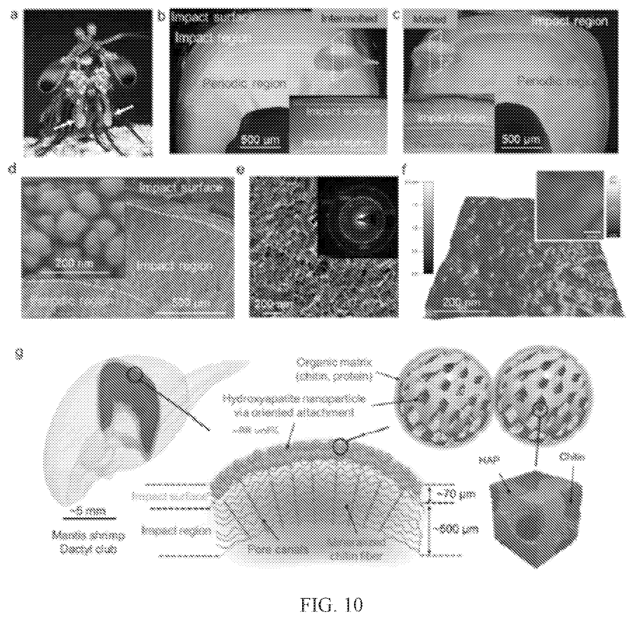

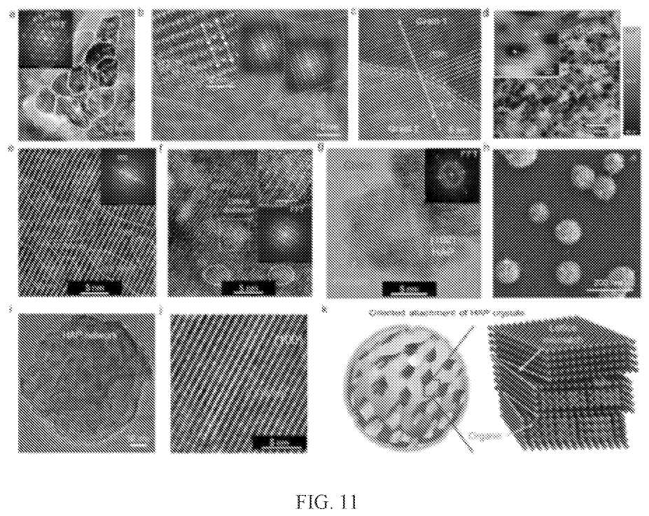

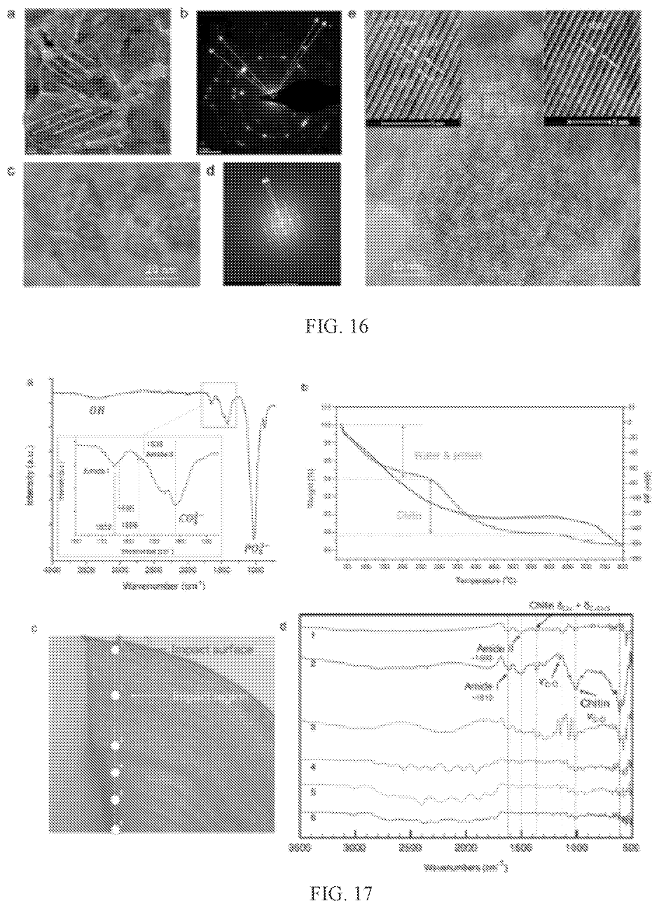

During feeding, the contact surface between the dactyl club of the mantis shrimp (FIG. 10a) and the hard shell of its prey is most vulnerable to severe damage under high strain-rate impact. Optical micrographs of transverse sections of the intermolted (i.e., newly formed) and molted (heavily used) dactyl clubs are shown in FIGS. 10b and c, respectively. The micrograph in FIG. 10b highlights that the dactyl club material consists of three independent regions: the outermost ˜70 μm thick coating, which we call the “impact surface”, consisting of highly mineralized hydroxyapatite (HAP) nanoparticles; beneath this is the “impact region” that has a herringbone-like structure of nanocrvstalline HAP mineralized chitin fibers; at the core of the club is the “periodic region”, comprised of mineralized (amorphous carbonated calcium phosphate) α-chitin fibers arranged in a helicoidal architecture²¹. Clearly, the intermolted specimen is completely intact, while the molted one is damaged due to thousands of impacts. In fact. FIG. 10c reveals that the outermost impact surface is significantly worn, suggesting loss of the particulate material from high contact stresses during impact. Differential interference contrast (DIC) optical micrographs (insets, FIGS. 10b and c) highlight the roughened surface of the molted sample, resulting from damage accumulation. This further suggests a potential source of energy dissipation in the club, via particle translation and ablation. Additional characterization of a transverse section from a fresh, intermolted dactyl club via scanning electron microscopy (SEM, FIG. 10d) shows the three distinct regions and highlights the nanoparticulate nature of the impact surface (inset red box, FIG. 10d). These densely packed nanoparticles, which are sub-100 nm, appear as aggregates. Transmission electron microscopy (TEM) of a coronal section of the impact surface validates that the particles (˜65.5±15.4 nm) are indeed crystalline HAP (FIG. 10e). Quantitative bimodal atomic force microscopy (AFM) imaging of a transverse section was used to obtain a topographical map of this particulate region with simultaneous nanomechanical characterization. An indentation depth map overlaid on the topographical map (FIG. 10f) reveals a similar indentation profile among particles. A higher-resolution indentation depth map (upper right, FIG. 10f) shows different nanoscale features within a single particle. Previous work suggested that particles in the impact surface region were single crystalline²¹. However, high-resolution TEM (HRTEM) indicates that these ˜65 nm “single” crystals consist of smaller (˜15.9±5.2 nm) primary grains (marked with yellow circles in FIG. 11a) that show a preferred orientation within each secondary particle. Comparison of the AFM and TEM images of the impact surface corroborate the average particle size (˜65.5±15.4 nm), and the relatively high packing density (˜88 vol %). Fast Fourier Transform (FFT) analysis of the micrograph in FIG. 11a confirms that the secondary particles are not single crystals, nor randomly oriented polycrystals, but rather highly aligned primary grains, likely formed via an oriented attachment (OA) process. Higher resolution imaging (FIG. 11b) of a few primary grains, as well as FFT of two adjacent grains, clearly indicates a slight misalignment of (100) planes. A high-resolution bright field image (highlighted by the blue box in FIG. 11b) of the interface between two grains, reveals a low angle (˜1.5°) grain boundary between adjacent primary grains (FIG. 11c). More evidence of the mesocrystalline nature of these particles, with misaligned primary grains as well as defects such as stacking faults, are provided in FIG. 16. The hierarchical structure of the impact surface of the dactyl club is shown in FIG. 1g, illustrating the hydroxyapatite nanoparticle-based coating on the outer surface of the club, acting as a protective layer for the underlying impact region.

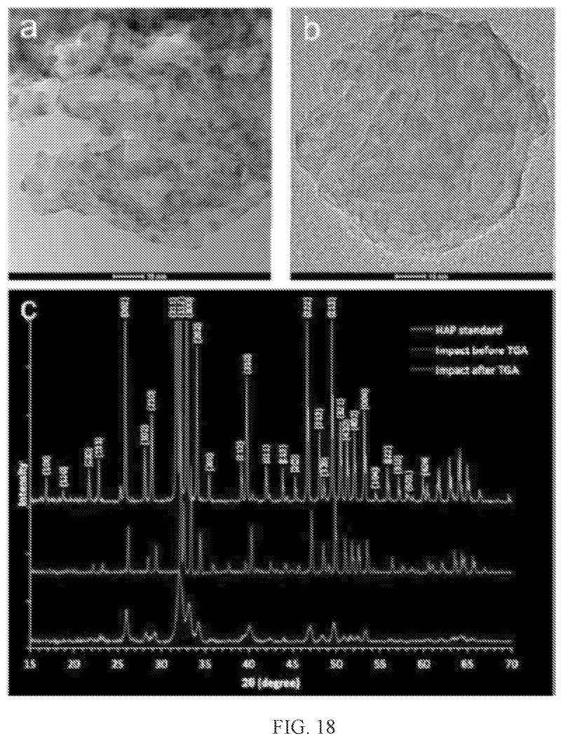

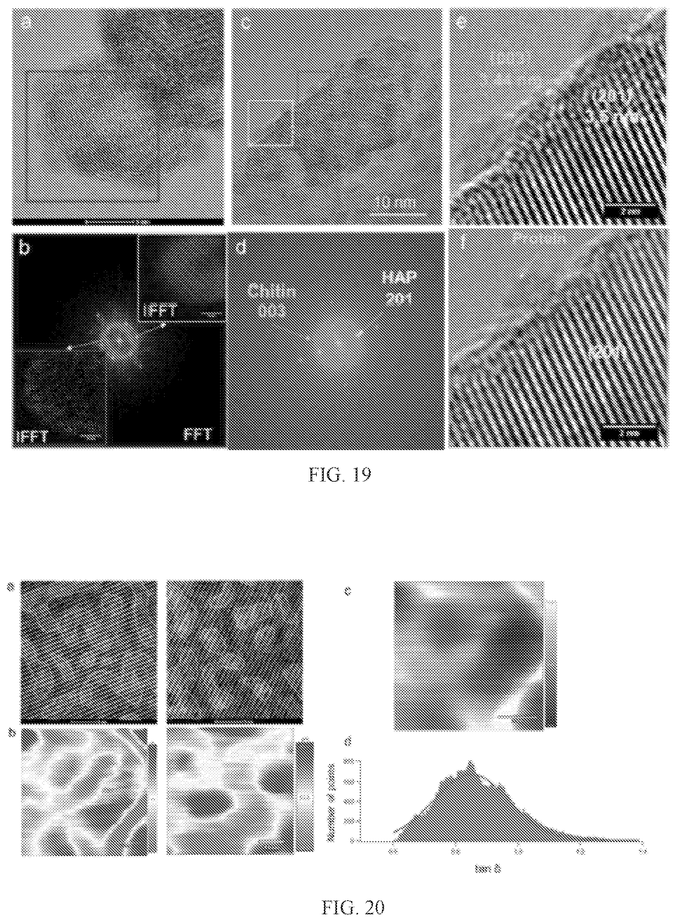

Closer observation within both secondary and primary particles reveals regions (˜3-4 nm) of lower contrast, (red arrows in FIGS. 11a and b), suggesting the existence of a secondary phase. Phase contrast maps acquired by AFM (FIG. 11d) further indicate the presence of two different materials within this particle system. Specifically, hydroxyapatite (HAP) was identified (via electron diffraction in TEM) as the mineral phase while a second, organic phase, likely consisting of a hydrated chitin and protein mixture (based on compositional analysis from the exoskeleton of crustaceans) was revealed. In fact, additional Fourier-transform infrared spectroscopy (FTIR) analysis confirms the presence of this hydrated organic phase (FIG. 17). Subsequent analysis by thremogravimetry (TGA) and differential scanning calorimetry (DSC) of the particles indicate the weight fraction of the organic phase is ˜17% (FIGS. 17, 18). Observations of an organic network inside inorganic biogenic crystals that is incorporated during the biomineralization process has been reported previously. Here, we find that the interpenetrating organic phase can affect atomic packing within the HAP crystal, inducing lattice distortions, as reported in a calcite-protein system. FIG. 11e highlights strained regions along the (100) planes within a crystal. These lattice distortions are found in regions where organic phases are present (as indicated by the change in lattice parameter in regions of brighter contrast, FIG. 11f). HRTEM micrograph of uranyl acetate and lead citrate stained samples illustrates the interface between chitin macromolecules and HAP phases. Chitin molecules are found adjacent to HAP nanocrystals, while proteins (indicated by high contrast stains) appear co-located with the chitin molecules, suggesting their role in assisting the biomineralization process (FIG. 11g, FIG. 19). To better understand the distribution of inorganic and organic phases, particles were annealed in air at 800° C. to remove organics, and subsequently imaged with SEM and HRTEM (FIGS. 11h and i). Even after annealing at a high temperature, the particles remain intact, albeit without the organic phase (FIG. 11h). HRTEM imaging (FIG. 11i) of a single particle reveals an interpenetrating, bi-continuous network of organic and inorganic phases, resembling bi-continuous copolymer nanoparticles. The 3D bi-continuous network within the particles were further confirmed via a series of TEM images collected at different tilt angles. By removing the organic phase, the distortion of (100) lattice disappears (FIG. 11j), which further validates the existence of the interpenetrating organic network. Based on TEM and AFM analyses, the volume fraction of the organic phase within these particles was determined to be ˜41±10 vol % (FIG. 20). This value is slightly higher than that determined from thermogravimetric analysis (i.e., ˜17 wt % or ˜32.7 vol %). This difference is likely due to the fact that the TGA data was calculated based on the assumption that the average density of the organic components is 1.35 g/cm³ (like that reported for proteins), whereas the density of the actual organic phase, which is hydrated, is likely lower.

Based on these observations, it is clear that the ultrathin coatings on the impact surface of dactyl clubs consist of bi-continuous nanoparticles. The inorganic component, calcium phosphate, has a low solubility under biological synthetic conditions (room temperature and near-neutral pH), and thus, reduction of the free energy in this system likely occurs via particle attachment (21). In many such biomineralization processes, the organic matrix interacts with mineral precursors, dictating the final morphology and polymorph. In fact, it is likely that the presence of the organic phase (in this case, chitin and proteins) guide the pathway by which nanoparticles aggregate, seemingly in a highly controlled manner (i.e., oriented attachment), enabling near-perfect alignment of neighboring crystalline domains (FIG. 11k). The subsequent interfaces between primary grains are low angle grain boundaries (˜1.5°). These low angle grain boundaries not only reduce the free energy of formation for this inorganic network, but can also potentially provide substantial toughening during impact via their ability to be fractured at these interfaces, analogous to tempered glass shattering into small pieces and dissipating large amounts of energy. In addition, the organic phases that influence the mineralization process can also be occluded within the inorganic crystal, providing significantly higher fracture toughness, hardness, energy dissipation and damping behavior. This will be discussed in the following sections.

### High Strain-Rate Micro-Impacts and Damping Behavior

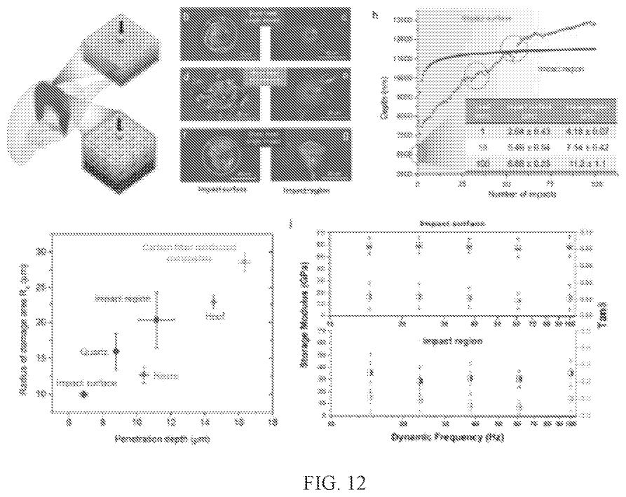

In order to understand the response of the composite particle-based coating of the impact surface during the high strain-rate impact feeding activities of the mantis shrimp, micro-impact tests (strain rate ˜10⁴ s⁻¹) were conducted on dactyl club samples (FIG. 12a), with and without the protection of this particulate coating (i.e., directly on the impact surface or on the impact region, respectively). Both spherical and cube corner indenter heads were used in these tests to mimic the conditions of blunt or sharp contacts the dactyl club might encounter. The damage fields of the impact surface (FIGS. 12b, d, and f) and impact region (FIGS. 12c, e, and g) were examined after (i) a single spherical (blunt) impact (FIGS. 12b and c), (ii) 100 sequential spherical (blunt) impacts (FIGS. 12d and e), and (iii) a single cube corner (sharp) impact (FIGS. 12f and g). Particle pile up is observed in the impact surface (FIG. 12b), while cracks are identified in the impact region (FIG. 12c). A similar scenario occurs in both samples after 100 impacts with the spherical indenter, but particles are worn off of the impact surface (FIG. 12d), while more extensive cracks propagate in the impact region (FIG. 12e). Different deformation mechanisms are found in samples impacted with a sharp cube corner indenter head (FIGS. 12f and g). Even at different loads (1, 10 and 100 mN), the observed penetration depth of samples with the impact surface present (the native dactyl club) was only one-half of that measured in the samples without it (i.e., directly on the impact region) (FIG. 12h). Additional strikes to the impact surface resulted in a gradual increase in the penetration depth, with depth fluctuations (shown with black circles) occurring, likely due to the rotation and translation of the composite nanoparticles. Conversely, the depth of penetration on the impact region increases for the first few impacts, but reaches a plateau with additional strikes. This can be explained by the different deformation mechanisms in the impact surface and impact region under these high strain-rate micro-impacts. The impact surface is able to localize damage and prevent crack initiation and propagation during multiple impacts, while more cracks are initiated and propagated in the impact region (i.e., without the presence of a protective nanoparticle coating). The calculated energy absorption density (i.e., energy absorption per volume) of the impact surface is ˜0.237 nJ/μm³, which is nearly twice of the value in nacre (˜0.128 nJ/μm³) under similar high strain rate impacts. FIG. 12i provides a comparison of penetration resistance and damage areas under high strain rate impacts in various biological and engineering structural materials. The impact surface has the smallest damage area and penetration depth, indicating the exceptional energy dissipation efficiency of the dactyl club at high strain rate conditions. These findings agree with our hypothesis that the particulate layer on the impact surface plays a significant role in preventing catastrophic failure of the club during thousands of high strain-rate impacts. By comparing the damage modes under quasi-static indentation and high strain-rate impacts, we note that the damage is more localized under high-strain rate impact, while more cracks initiate and propagate between the larger, secondary nanoparticles in the samples subjected to quasi-static indentation (FIG. 22). Here, it is likely that under high strain-rate impact, chitin and proteins within and between the nanoparticles stiffen, leading to the localized failure of the particles, and cracking between the particles is thus limited. This strain-rate dependent behavior suggests that the ultra-thin biological coating found in the mantis shrimp dactyl club is designed to avoid catastrophic damage during high strain-rate impacts and ensure efficient feeding and thus survival.

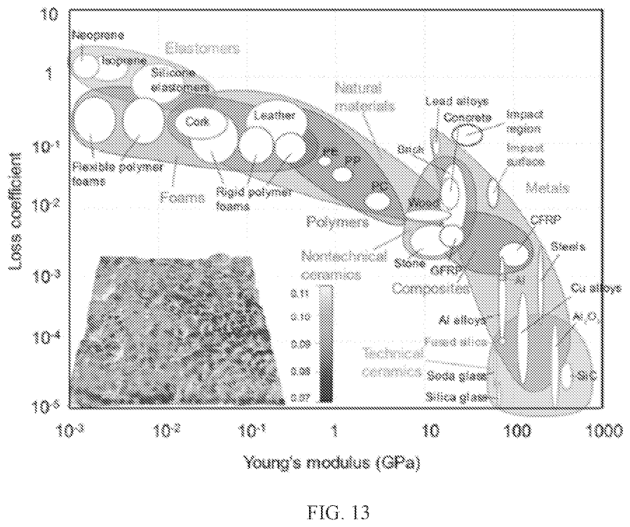

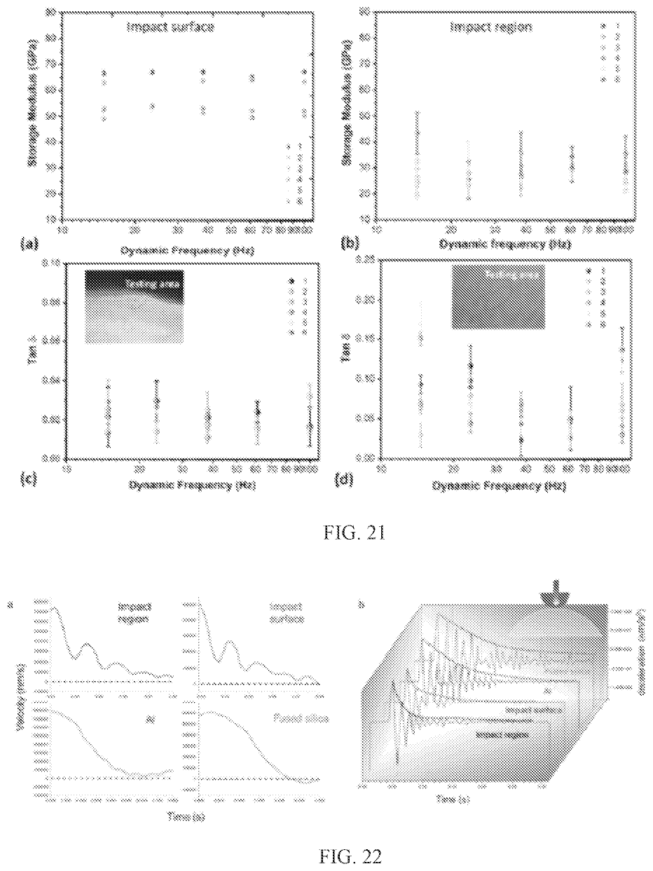

In addition to localizing the damage area and preventing crack propagation, the particulate layer has promising damping effects to accommodate both high acceleration and velocity impacts. The loss coefficient and storage modulus of the impact surface and impact region were measured using AFM and a nanoindenter equipped with nanoDMA III (see FIGS. 20 and 21). The storage modulus of the impact surface is 58.9±8 GPa, with a loss coefficient 0.02±0.01, while the impact region has a modulus 32.6±12 GPa, and a higher loss coefficient 0.1±0.07 (FIG. 12j). The Ashby plot of stiffness and loss coefficient in biological and engineering materials shows the tan S value of both the impact region and the impact surface are larger than most metals and composites with similar stiffnesses (FIG. 13). In the impact surface, this might be attributed to the bi-continuous nature of the nanoparticles. As a result, the deceleration in the impact surface occurs faster than that in aluminum and fused silica, indicating better damping properties without sacrificing the stiffness (FIG. 21). The impact velocity vs. time further shows more damping and energy dissipation occurring in the impact region and impact surface than that in Al and fused silica (FIG. 21). Carbon fiber reinforced polymers that could be used for automobiles and aircraft, have a similar stiffness to the impact surface coatings (˜70-100 GPa), yet are an order of magnitude lower in loss coefficient, suggesting the implementation of these coatings could yield improvements in noise and vibration damping. The designs presented in these bi-continuous particles indeed may be used in a broad range of engineering coatings in large structures (e.g., buildings, aircraft and wind turbines) as well as in small constructs such as electronics, to ensure protection against vibration and impact damage, while maintaining robust stiffness.

### Nanoscale Energy Dissipation Mechanisms

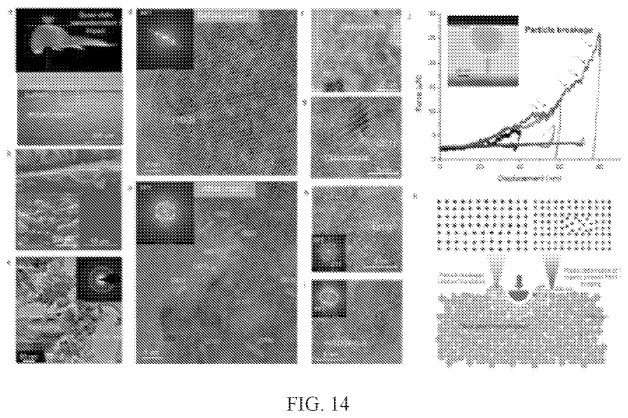

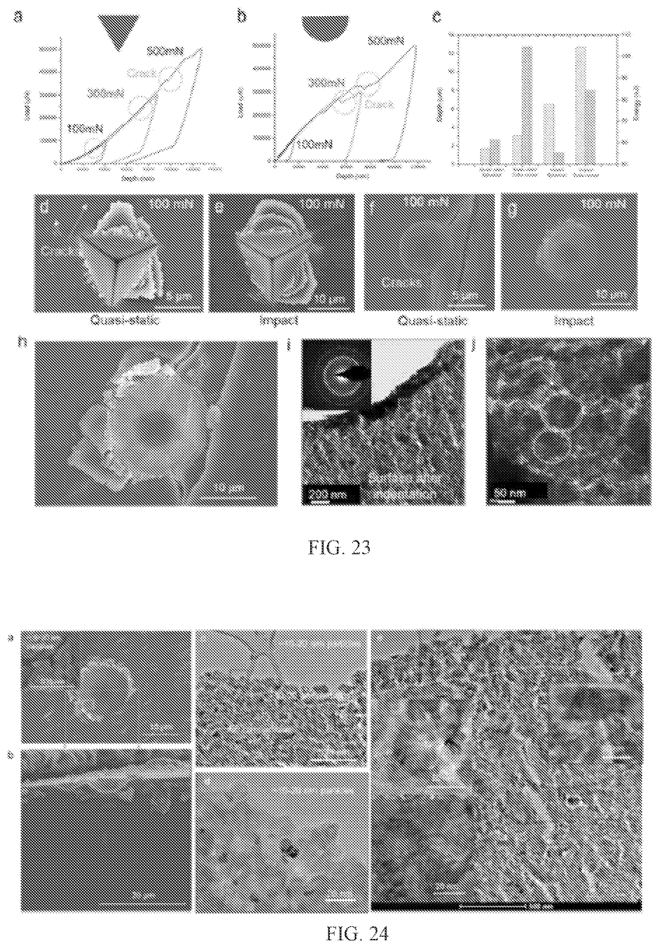

After impact tests were performed, potential mechanisms of energy dissipation and damping behavior within the nanoparticle-based coatings were evaluated. The region of impacts were performed on the coronal surface of the club, with the region affected highlighted by the green box in FIG. 14a. It is clear that quasi-static indentation incurred no changes of HAP particle size and shape (FIGS. 23i and j), while high strain rate (˜10⁴ s⁻¹) impacts lead to significant fracture of secondary HAP particles into smaller (˜10-20 nm) primary grains (FIGS. 14b and c as well as 24) and thus dissipating some of the impact energy. Particle breakage can also be validated via comparison of SAED patterns from specimens before and after impact, where intact samples consisted of a mesocrystalline structure (FIGS. 16a and b), while impacted samples were pulverized and consisted of randomized grains (inset, FIG. 14c). Analysis of grains in impacted samples via HRTEM revealed fractured secondary particles with subsequent randomization of the orientations of the resultant primary grains (FIGS. 14d and e), providing further evidence of energy dissipation. In addition to the breakage of secondary nanoparticles, the high strain rate impacts clearly induced crystal imperfections in HAP crystals, with dislocation nucleation, glide, and annihilation dislocations and regions of amorphization (FIGS. 14f-i), which have also been observed in nacre after high strain-rate impact. Edge dislocations in (211) crystal planes are indicated in FIG. 14g, while FIG. 14h shows the same planes without any imperfections. Furthermore, certain regions within the crystalline HAP particles appeared to be amorphous (highlighted in purple, FIG. 14i), losing their long range ordering after high strain impact. We highlight these changes as additional sources of energy dissipation. In fact, high strain-rate or shock induced dislocation formation as well as amorphization were reported in synthetic and natural ceramics, and were considered as efficient energy dissipation mechanisms.

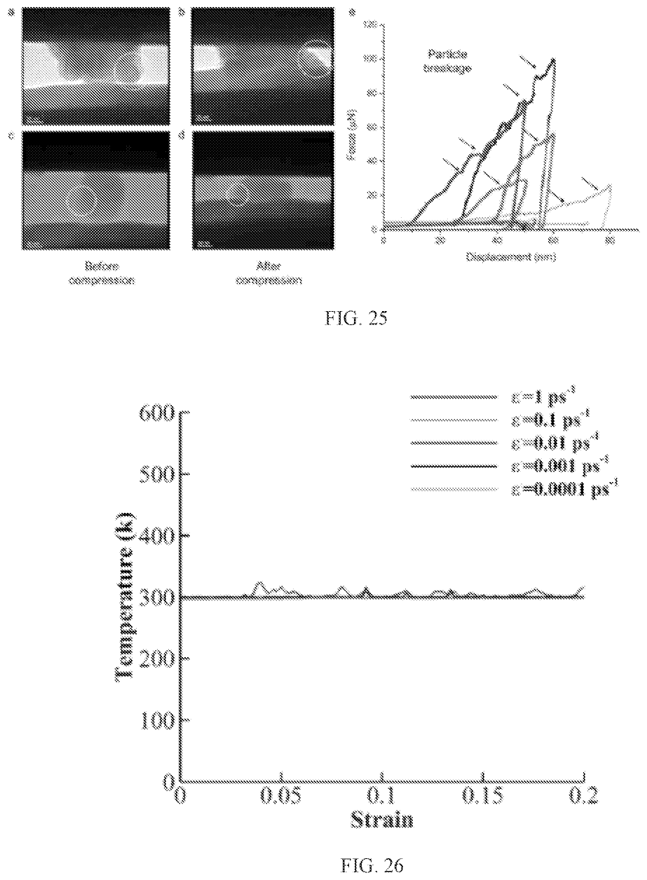

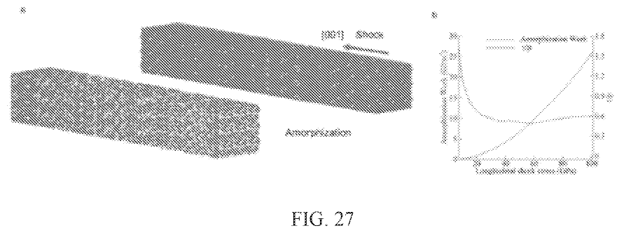

To quantify the amount of energy dissipated by compressing and breaking the secondary particles, in-situ TEM compression tests on single HAP nanoparticles, separated from the club, were performed. The load-displacement curves are shown in FIG. 14j, in which different loading cycles are marked in different colors. The plateaus on the curves indicate cracking events and particle breakage, leading to a total energy dissipation of 6.23×nJ until particle failure (FIG. 25). The energy dissipation density is ˜4.55 nJ/μm³, which is an order of magnitude higher than a previously reported strong and tough bioceramic armor (˜0.29 nJ/μm). In addition, the nanoparticle is able to recover to its original shape after ˜80% compression. The large energy dissipation as well as ability to recover is attributed to the bi-continuous nature of the hydrated organic networks. A schematic shown in FIG. 13k highlights the deformation and energy dissipation mechanisms of these nanoparticle coatings under high strain-rate impact. The total energy dissipation calculated from the area under the stress-strain curves is the contribution of plastic deformation from the organic network while elastic energy is released by crack initiation and propagation in the hydroxyapatite mesocrystalline network. In addition, by implementing the bi-continuous design into the nanoparticle structures, the stiffness and strength are significantly increased compared to structures with non-integrated phases, such as traditional composites, leading to a higher energy absorption. The advantages in energy absorption of bi-continuous phases have been demonstrated in other materials systems including a carbon/epoxy system. However, this is the first time that the ceramic/polymer bi-continuous nanostructures are observed in biological materials, specifically in structures that undergo high strain rate impacts, suggesting promising energy absorption capabilities. In fact, researchers have been applying block copolymer and sol-gel methods to realize synthetic pathways to bi-continuous nanostructures. Recently, 3D printing of resins that phase separate has been successfully used to fabricate large volume samples with bi-continuous nanostructures. By combining the current synthesis and advanced manufacturing methods with design elements from biological structures, engineering and fabricating impact-resistant and energy absorbent bi-continuous structures for many applications can be realized.

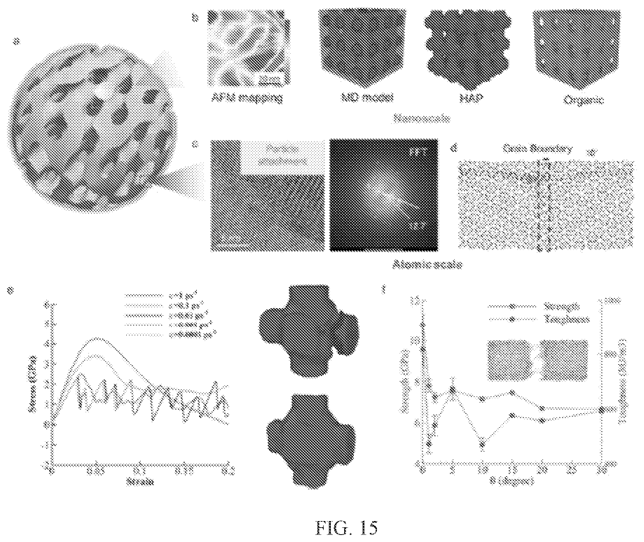

To validate our hypotheses regarding the multiple mechanisms of energy dissipation, molecular dynamics simulations (MD) were performed to evaluate the mechanical behavior at two length scales: at the nanoscale, the strain rate dependent behavior of the bi-continuous network was studied; at the atomic scale, the relation between the angle of the misalignment in the oriented attached particles and the amount of energy dissipated by breakage of the low angle grain boundaries during the high strain rate impact events were investigated (FIG. 15). FIG. 15a is a schematic showing the bi-continuous networks in the HAP nanoparticles. HAP and organic phases are marked in blue and red, respectively in both the AFM phase contrast mapping and MD models (FIG. 15b). A simple cubic interpenetrating model was constructed to represent the bi-continuous network we observed in the nanoparticles from the impact surface. While at a smaller scale, primary particle attachment at the periphery of the HAP bi-continuous particle is noticed (FIG. 15c). The overall misalignment angle between mesocrystals through the whole particle is 12.7°, verified by the FFT pattern. MD models of the HAP crystals with different grain boundary angles were created to simulate the mesocrystalline structure of the impact surface (FIG. 15d). Simulations of fracture of the bi-continuous particle suggest that the stiffness and strength of the nanoparticles increase as the strain rate increases (FIG. 15e). The deformation of the HAP is more uniform at higher strain rate, while more localized at lower strain rate. These correspond to the experimental results that under high strain rate impacts, the uniform stress distribution and lack of plasticity leads to the fracture of the bi-continuous particles (FIGS. 14d and e). We note that by having small grain boundaries, the overall strength of the HAP crystals decreases, but enables fractures to occur at these grain boundaries under high strain rate impact (FIG. 15f). The energy dissipation density of grain boundary fracture is ˜0.6 nJ/μm³, which is slightly higher than the overall impact energy absorption density in the experiments (0.237 nJ/μm³). This indicates the breakage of particles can be the main energy dissipation mechanism under high strain rate impact. In addition, the amorphization work calculated via MD simulation is ˜0.038 nJ/μm³, accounting for ˜16% of the overall impact energy (FIG. 23).

### Conclusions

This study provides experimental observation as well as computational validation of the effects of high strain rate, micro-scale impacts on biological composites, specifically the ultrathin (˜70 μm) nanoparticulate coatings of the dactyl club. This highly dense coating shields the underlying composite structure within the dactyl club, decreasing the penetration depth of a high strain rate impact by half. We identified a uniquely architected nanostructure: a bi-continuous network of organic and mesocrystalline hydroxyapatite nanocrystals, that provides significant capacity for energy dissipation. Multiscale toughening mechanisms were proposed and validated: translation, rotation, and plastic deformation of particles; formation of new interfaces from particle breakage (energy dissipation density ˜4.55 nJ/μm³ under quasi-static compressions. ˜0.237 nJ/μm³ at high strain-rate impacts); dislocation generation and amorphization of HAP mesocrystals. The combination of a stiff inorganic and an elastomeric organic in an interpenetrating network confers impressive damping properties to the coating without compromising its stiffness. The observed damping behavior of these HAP-based nanoparticles is greater than that demonstrated in most metals and technical ceramics.

These observations suggest the bottom-up controlled synthesis of these materials, which is constrained by biological synthetic parameters (i.e., room temperature and limited solubility), can still lead to well-engineered structures via highly orchestrated (i.e., kinetically controlled) growth. These mesocrystalline materials, likely formed via oriented attachment (OA) around chitin/protein networks that are occluded inside the inorganic phase. not only reduces the energy of formation of these particles, but also leads to a lower barrier to fracture, which enables large and localized energy absorption. These designs have significant implications in the world around us because they illuminate a new generation of advanced materials in a broad arena of application, including impact and vibration resistant coatings for buildings (e.g., in tornado and hurricane prone regions), body armor, aircraft and automobiles, as well as in abrasion and impact resistant wind turbines.

### Materials and Methods

### Sample Preparation

Live specimens of Odontodactylus scyllarus were obtained from a commercial supplier and maintained in a lab seawater system. The molting cycles of the specimens were monitored and recorded. Fresh and intact dactyl clubs were collected one week after molting. Heavily damaged clubs were collected from the molted specimens. Optical micrographs (Zeiss, Oberkochen, Germany) were obtained of both intact and damaged samples via polished cross-sections. Samples were first embedded in epoxy (System 2000, Fibreglast. USA), and then polished with progressively finer silicon carbide and diamond abrasive down to 50 nm grit. Fractured samples for scanning electron microscope (SEM) imaging were acquired using a sharpened chisel. Ultramicrotome (RMC MT-X, Boeckeler Instruments, USA) was utilized to polish sample surfaces, which were further characterized with nanoindentation, micro-impact testing, and atomic force microscopy (AFM).

### Electron Microscopy

Fractured surfaces, microtomed sections, and damaged surfaces of dactyl clubs via quasi-static indentation or high strain-rate micro-impacts were examined using scanning electron microscopy (TESCAN MIRA3 GMU, Brno, Czechia). Samples were mounted to aluminum pin mounts and coated with platinum and palladium for 60 seconds before imaging.

For transmission microscopy imaging, intact fresh dactyl club specimens were first fixed using glutaraldehyde (2.5%) aqueous sodium phosphate buffer solution (0.1 M, pH=7.2) for 2 hours and then washed in deionized (DI) water three times for 5 min each. Samples were then serially dehydrated in ethanol and embedded in resin (Epofix Cold-Setting Embedding Resin, Electron Microscopy Sciences. USA) in silicon molds at room temperature overnight. ˜70 nm thin sections were then acquired by using ultramicrotome (RMC MT-X, Boeckeler Instruments, USA) and a diamond knife (PELCO, Ted Pella, USA). The thin sections were then placed on carbon coated copper grids for further imaging. Another set of grids with microtomed thin sections were stained with 1% uranyl acetate solution for 10 minutes, followed by rinsing with DI water 3 times and drying with filter paper. The samples were further stained with 0.1% lead citrate for 60 seconds within a CO₂ free environment by putting NaOH pellets in the staining chamber. TEM and HRTEM images were taken by a FEI Tecnail2 at 120 KV and FEI Titan Themis 300 at 300 KV (Thermo Fisher Scientific, Waltham, Mass., USA), respectively.

### Atomic Force Microscopy

Coronal and transverse surfaces were polished via ultramicrotome. Quantitative bimodal atomic force microscopy (AFM) imaging, known as AM-FM. was performed on both surfaces using a commercially available Cypher ES AFM (Oxford Instruments Asylum Research). This technique allowed for simultaneous tracking of topography, phase, and amplitude using amplitude modulation of the first oscillatory eigenmode of the cantilever, while frequency shift and energy dissipation are tracked with frequency modulation of the second eigenmode at a much smaller amplitude. Together, these enabled the calculations of indentation depth, storage modulus, and loss tangent (tan δ) of a sample. Briefly, for tan S, the cantilever resonance frequency and stiffness were calibrated with the GetReal software protocol, while the optical lever sensitivity and absolute phase, ϕ_{free}, were set by fitting a thermal resonance spectrum. After choosing the resonant frequency amplitude, A_{free}, for the free (non-surface-interacting) cantilever, the tip-sample interaction amplitude, Aᵢₙₜ, and phase, ϕᵢₙₜ, were collected at every pixel (i.e. during imaging) and used to calculate loss tangent via the equation tan

$$δ = \frac{{A}_{free} sin {ϕ}_{int} - {A}_{int} sin {ϕ}_{free}}{{A}_{free} cos {ϕ}_{int} - {A}_{int} cos {ϕ}_{free}}$$

in real time. An Olympus AC160TSA-R3 cantilever was used (Au reflex coating), and driven with blueDrive™ photothermal excitation. The nominal spring constant, first eigenmode resonance, and tip radius of this lever are k=26 N/m, f=300 kHz, and R=7 nm, respectively. The experimentally measured values for this cantilever's first eigenmode were k1=34.5 N/m, f1=259.3 kHz, and Rtip=7.7 nm. The measured values for the second eigenmode were k2=613.4 N/m and f2=1.455 MHz.

### Nanoindentation and Nano DMA

Nanoindentation on both transverse and coronal polished surfaces of dactyl clubs were performed using Hysitron TI-980 Tribolndenter (Bruker Nano Surfaces, Minneapolis, Minn., USA) utilizing nanoDMA III. To measure the composite response of impact surface coating, a 1 μm diamond cono-spherical probe was selected for testing. Frequency sweep tests were conducted at different locations on the impact surface and impact region at a fixed normal load (1.5 mN) using the reference frequency technique. The probe oscillation frequency was varied logarithmically from 9 Hz to 100 Hz. Storage (E′), loss Modulus (E″) and tan(S) are calculated using following equations.

$${E}^{′} = \frac{{k}_{s} \sqrt{π}}{2 \sqrt{{A}_{c}}} , {E}^{″} = \frac{ω {C}_{s} \sqrt{π}}{2 \sqrt{{A}_{c}}} , tan δ = \frac{{E}^{″}}{{E}^{′}} \qquad ( 1 )$$

Where. ‘kₛ’ is storage stiffness, ‘C_{S}’ is loss stiffness, ‘ω’ is the frequency and ‘A_{c}’ is the contact area. The tip area function was generated via fused quartz testing in the usual fashion.

### Thermogravimetry (TGA) and Differential Scanning Calorimetry (DSC)

Hydroxyapatite nanoparticles were acquired from the impact surface of six clubs. The HAP powders were then tested with TGA/DSC. TGA and DSC was performed on a TGA/DSC 3+ Mettler Toledo under flowing air from 25° C.-800° C. at a heating rate of 10° C./min. The post-annealed particles were further characterized with SEM and TEM.

### Quasi-Static Indentation and High Strain-Rate Micro-Impact Tests

Flat coronal surfaces were prepared by ultramicrotome, which were further used in quasi-static nanoindentation and micro-impact tests. A TI 950 Tribolndenter (Broker, USA) was used to perform the quasi-static nanoindentation tests. Cube corner and spherical (tip radius 5 μm) diamond indenter heads were used during the tests. Specimens were loaded to 100 mN, 300 mN and 500 mN, respectively. High strain-rate micro-impact tests were conducted on the NanoTest Vantage (Micro Materials, Wrexham. UK). The impact heads were either cube corner or spherical (tip radius 5 μm) diamond indenter heads, which were the same used in quasi-static nanoindentation tests. The acceleration distance was 10 μm, reaching the highest strain rate ˜10⁴ s⁻¹. The impact load was set at 100 mN. Both the impact surface and the impact region of the dactyl club specimens were tested in quasi-static indentation and under micro-impact. The damaged areas after indentation and impacts were subsequently imaged by SEM and HRTEM. Nacre, equine hoof, quartz and carbon fiber reinforced composites were purchased from commercial sources. Samples were embedded in epoxy and polished for further micro-impact tests. The impact testing conditions were the same as the tests performed on the impact surface and impact region. The damaged areas were further imaged using optical microscopy and SEM. The total impact energy can be calculated as E=½ mv²; where m is the mass of the indenter head and v is the impact velocity. The total volume of deformation can be estimated from V=πdR_{d}²/3, in which R_{d} is the radius of the damage area and d is the penetration depth. Thus, the energy absorption density (energy absorption per volume) can be calculated as EV.

### In-Situ TEM Compression Tests

Hydroxyapatite (HAP) nanoparticles were acquired by first scratching a fresh dactyl club surface with a razor blade to obtain the HAP powders. The powders were then dispersed in DI water, and sonicated for 4 hrs. The suspension was subsequently centrifuged for 5 min at 3000 rpm. The size of the HAP nanoparticles was confirmed by SEM and dynamic light scattering (Zetasizer Ultra, Malvern Panalytical Ltd, Malvern, UK). The supernatant was then dropped onto a 1 μm silicon wedge for further in-situ TEM compression tests. A Hysitron PI 95 TEM Picolndenter (Bruker, USA) was used to perform the compression tests in a Tecnail2 TEM (Thermo Fisher Scientific, Waltham, Mass., USA) at 120 KV. A flat punch indenter head with a tip diameter of 1 μm was used in the compression test. The loading rate was 1 nm/s.

### Molecular Dynamics Modeling

To understand the effect of grain boundary on strength and toughness of HAP, molecular dynamics simulations (MD) were performed using LAMMPS package and by employing INTERFACE-CVFF forcefield that was previously developed for structure and elastic modulus of HAP and is in good agreement with experimental data. In addition, the strength of HAP from our simulations are in agreement with those reported values from ab initio calculations. In this study, the monoclinic structure of HAP with space group P21/b and unit cell parameters of 9.421 Å×18.843 Å×6.881 Å with α=90°, β=90° and β=120°, according to the experimental observations, were used. To study the grain boundary effect, eight models of HAP bi-crystals, representing different misorientation angles of θ=0°, 1°, 2°, 5°, 10°, 15°, 20° and 30°, were generated (as shown in FIG. 14d for θ=10°). For each model, the HAP unit cell is initially replicated by 9×5×4 to obtain a large super cell with dimensions of 84 Å×82 Å×30 Å, and then the misorientation is generated by rotating the left and right crystals by −θ/2 and +θ/2 around the z axis ([001]), respectively (periodicity is retained in [001] direction). Finally, the atoms on the left and right crystals are carefully deleted along the x axis ([100]) and y axis ([010]) directions to form an interface and periodicity in those directions, respectively (the final dimension of each crystal is 30 Å×30 Å×30 Å). After construction of the model, the structure is minimized using a steepest descent method and then is relaxed at 300 K and 1 atmosphere pressure in NPT ensemble for 1 ns, with Ifs time steps. Then, to maintain periodicity in all directions, a vacuum is added in the x direction between periodic images by expanding the box size to 60 Å. The structure is then equilibrated at 300 K and 1 atmosphere pressure for 500 ps in a NPT ensemble (pressure is only controlled in y and z directions) and then is equilibrated at 300 K for another 500 ps in a NVT ensemble. After preparation and equilibration of the bi-crystal, a steer molecular dynamics (SMD) method with a high stiffness of 500 Kcal/molÅ² and with a constant velocity of 0.025 Å/ps was used to apply tensile loading to the free boundary atoms of the right crystal (atoms within 5 Å distance from rightmost atoms), while keeping the free boundary atoms of the left crystal (atoms within 5 Å distance from leftmost atoms) fixed. During the SMD simulation, the position of Ca and P atoms at the boundaries in the x direction were kept fixed and stress and strain values were recorded to obtain the strength (maximum stress) and toughness (approximately the area below stress-strain curve) for each misorientation (as shown in FIG. 140.

To calculate the amorphization work in HAP during high speed impact, nonequilibrium molecular dynamics (NEMD) simulations of shock conditions were performed using a piston moving along the z axis [001] with constant velocity. The HAP crystal structure and force field used for shock simulations are the same as those mentioned above. To have a large sample for shock propagation, the unit cell is replicated by 3/2/20 to the final approximate dimensions of 30 Å×30 Å×200 Å. Since the periodicity cannot be applied in the shock direction, the dimension of the sample in the shock direction is much larger. The sample is then minimized using the steepest descent method and then is equilibrated at 300 K in NVT ensemble for 500 ps with 0.5 fs time steps while the periodic boundary conditions are only applied in the [100] and [010] directions (transverse to the shock propagation). The equilibrated structure is checked by observing the variation of root-mean-square-deviation (RMSD) during the simulation. The piston is then moved along [001] direction with a velocity up to 5 km/s associated with 100 GPa pressure. For amorphization of HAP under shock compression and following a recent work for amorphization of silicon carbide, the Patel-Cohen formulation for the effect of pressure and shear stress on amorphization work is employed here as follow:

W=P∈+τγ (2)

Where W is amorphization work. P hydrostatic pressure, ∈ is longitudinal strain in the shock direction, τ is shear stress and γ is shear strain. The simulation results for Wand τ/P ratio at different longitudinal pressure and snapshots of initial and final structure after shock propagation are shown in FIG. 23. For the impact stress of ˜0.98 GPa in the current impact tests, amorphization work and τ/P are about ˜0.038 GJ/m³ and 1.4 respectively.

For understanding the strain-rate effect on the bi-continuous composite of HAP nanoparticle and organic phase, a coarse-grained (CG) molecular dynamic model was used to represent the mechanical behavior of HAP and organic phase in a simple cubic bi-continuous structure (as shown in FIG. 14b with blue and red colors respectively). The interaction of CG beads in HAP and organic phase are defined through Morse potential as follow:

E=D₀[e^{-2α(r-r}^{₀}⁾−2e^{-α(r-r}^{₀}⁾] (3)

Where E is pair-wise potential, Do is the potential depth, r₀ is the equilibrium distance between pairs and a is a parameter that controls the width of the potential (the hardness/softness of the interaction). The CG structure is a fcc structure with 1 nm lattice distance and total dimension of 20 nm×20 nm×20 nm (FIG. 14b). For each bead the masses of 450 gr/mol and 150 gr/mol are selected to represent the density of 3.2 gr/cm³ and 1.1 gr/cm³ for HAP and organic phase respectively. The values of Do, r₀ and a are selected in a way to produce the mechanical properties of HAP as in the Morse potential, the failure strain, maximum force and stiffness are defined by ε_{f}=ln2/(αr₀), Fₘₐₓ=αD₀/2 and K=2α²D₀ respectively. For soft phase. the strength and stiffness are assumed to be one order of magnitude smaller and failure strain is assumed to be 50% higher than HAP's values. For the interaction of soft phase with HAP, Lorentz-Berthelot mixing rule for D₀, and α were used. After construction of the model, the system is equilibrated at 300 K for 500 ps in NVT ensemble and then is equilibrated at 300 K and 1.0 atmospheres pressure for 2 ns in NPT ensemble. The compressive strain with various strains rates (1-1E−4 ps⁻¹) is then applied to the system in one direction by changing the box size, while the pressure is kept fixed at 1.0 atmospheres at other two directions. The stress-strain curves for different strain rates and deformed structure of HAP nanoparticle at high and low strain rates are shown in FIG. 15e.

With the analysis above of the mechanisms that provide superior material properties, it is desired to construct synthetic materials that provide some or all of the identified properties of the mantis shrimp. As noted above, a specific example material includes a bi-continuous phase material with at least one stiff phase and at least one compliant phase where the ratio of bulk moduli of the stiff phase to the compliant phase is greater than 2. One example includes HAP nanoparticles as the stiff phase, and a polymer as the compliant phase. Several examples of different stiff phase materials and compliant phase materials are described in more detail in the examples below.

Some embodiments can describe an ultra-hard, composite material that can comprising a plurality of phases, where the plurality can comprise at least one stiff phase and at least one compliant phase, where the stiff phase can form an interpenetrating network within the compliant phase, the interpenetrating network can be described as bi-continuous phase, such as a gyroid phase, where the ratio of bulk moduli of the stiff phase to the compliant phase is greater than about 2. In some materials, the ratio of bulk moduli of the stiff phase to the compliant phase can be from about 100 to about 3000. For some materials, the stiff phase can comprise aromatic polyamides (i.e., aramids), ultra-high-molecular-weight polyethylene (UHMWPE), aluminum (e.g., α-Al₂O₃), boron (e.g., boron nitride, cubic boron nitride, boron carbide), silicon (e.g., Sitz, silicon nitride, silicon carbide), titanium (e.g., titanium nitride, titanium carbide, titanium diboride). tungsten (e.g., tungsten nitride, tungsten carbide), zirconium (e.g., zirconium nitride, zirconium carbide), niobium (e.g., niobium nitride, niobium carbide), vanadium (e.g., vanadium nitride, vanadium carbide), rhenium (e.g., rhenium diboride, rhenium nitride, rhenium carbide), molybdenum (molybdenum carbide, molybdenum nitride, molybdenum boride), iron, diamond, graphene, carbon nanotubes, or fullerene. In some materials, the compliant phase can comprise chitin, chitosan, cellulose, lignin, hemicellulose, or proteins. With some composite materials, the compliant phase can comprise poly-epoxide, polyvinyl alcohol (PVA), low density polyethylene (LDPE), high density polyethylene (HDPE), polycarbonate (PC), polystyrene (PS), polypropylene (PP), polyurethane, polytetrafluoroethylene (PTFE), polyvinyl chloride (PVC), polyamide (Nylon), polyethylene glycol (PEG), polyethylene terephthalate (PET), polybutylene terephthalate (PBT), polytrimethylene terephthalate, polyethylene naphthalate, polymethylmethacrylate (PMMA or acrylic), poly-epoxide, polyoxymethylene (POM or acetal), acrylonitrile butadiene styrene (ABS), polyglycolic acid, polylactic acid, polycaprolactone, polyhydroxyalkanoate, polyhydroxybutyrate, polyethylene adipate, polybutylene succinate, or poly(3-hydroxybutyrate-co-3-hydroxyvalerate). In some embodiments, the material matrix can comprise a poly-epoxide, or epoxy. In some embodiments, the compliant phase can comprise lead, gold, silver, tin, zinc, aluminum, thorium, copper, brass or bronze. For some material embodiments, the ratio of volume fill fraction of the stiff phase, as measured by volumetric ratio, can be from about 0.1 vol. % to about 99.9 vol. %. In some materials, the ratio of volume fill fraction of the compliant phase, as measured by volumetric ratio, can be from about 0.1 vol. % to about 99.9 vol. %. For some material embodiments, the material can define particles. In some embodiments, the size of the particles can range from about 1 nm to about 5 mm.

Some embodiments describe a method of making the aforementioned composite material, where the method can comprise: depositing different materials such that a 3-D bi-continuous network of a stiff phase and a compliant phase are generated, where the steps of depositing can be done by 3-D printing, selective chemical vapor deposition, sol-gel processing, or other solution based processes, such as co-precipitation or hydro/solvothermal methods.

Other embodiments describe a method of making the aforementioned composite material, the method can comprise: mixing a cation with a block co-polymer in a solvent where one of the domains of the polymer contains moieties that will bind to the cation to form a mixture, removing the mixture from the solvent to form bi-continuous networks in a material. Some methods can further comprise annealing the mixture to burn off the non-cation binding portion of the polymer to yield a stiff phase and infiltrating the matrix with a compliant phase material. Other methods can further comprise exposing the mixture to a reducing condition to chemically nucleate cations bound to the portion of the polymer. Some methods can also further comprise exposing the mixture to an etching condition to chemically remove the non-cation binding portion of the polymer to yield a stiff phase and infiltrating the matrix with a compliant phase material. Other methods can further comprise annealing the mixture to burn off the non-cation binding portion of the polymer to yield a compliant phase and infiltrating the matrix with a stiff phase material. In some embodiments, the method can further comprise exposing the mixture to an etching condition to chemically remove the cation-bound portion of the polymer to yield a compliant phase and infiltrating the matrix with a stiff phase material.

In other examples, apart from cations, inorganic or metallic molecules can be attached to one part of a block co-polymer. The inorganic or metallic molecules then facilitate phase separation that is used to form bi-continuous networks in a material. In one example, the inorganic or metallic molecules include extended network molecules. In one example, the inorganic or metallic molecules include oligomers. In one example, the inorganic or metallic molecules include nanoparticles.

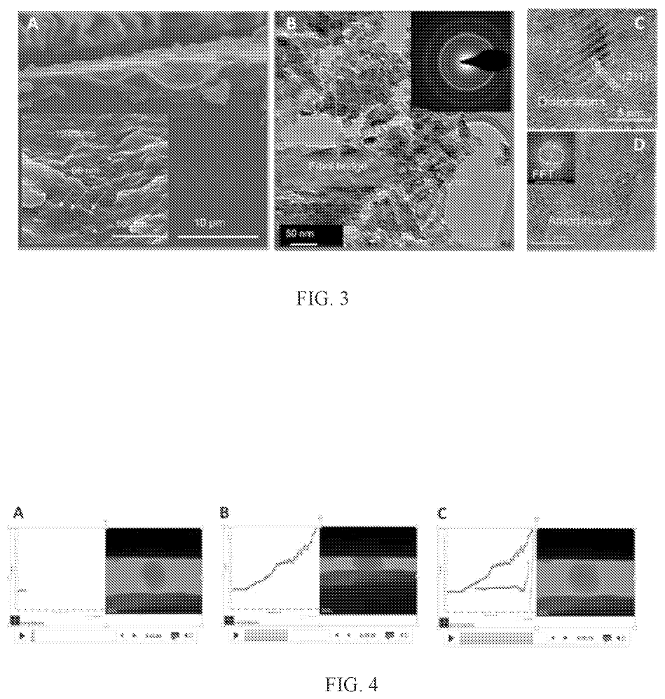

The present disclosure provides an improved composite material which is particularly useful in dampening impact forces when subjected to a significant amount of impact energy. Using the mantis shrimp dactyl club as inspiration (sec FIGS. 1, 2, 3 and 4), man-made materials can be synthesized to provide impact energy dissipation. As shown in high-resolution micrographs in FIGS. 1D and 1E, in the dactyl club system there are protein and chitin organic phases interpenetrated with a hydroxyapatite network. FIG. 1F depicts the inorganic network after high temperature treatment, indicating intact and porous framework of the hydroxyapatite phase. The bi-continuous nanoparticles observed on the impact surfaces of the mantis shrimp show promising damping and energy dissipation, which have been tested and confirmed with mechanical tests via atomic force microscopy (AFM) (FIG. 3) and in-situ compression of a single particle in a transmission electron microscope (FIG. 4). While not wanting to be limited by theory, the inspired composite material designs presented herein are thought to similarly effectively resist high strain rate impacts and have relatively high damping properties at the same time.

The term “bi-continuous” as used herein refers to the character of the phase interface between two or more components of the material, such that the majority of the phase interfaces form a network of intersecting, continuous interfaces either as individual groups or together as a whole.

### Composite Material

Some embodiments describe an ultra-hard, composite material, 100, where the material is comprised of a plurality of phases, the plurality comprising at least one stiff phase, 101, and at least one compliant phase, 102, where the stiff phase forms an interpenetrating network within the compliant phase. In some embodiments, the interpenetrating network can be described as bi-continuous phase, such as a gyroid phase.

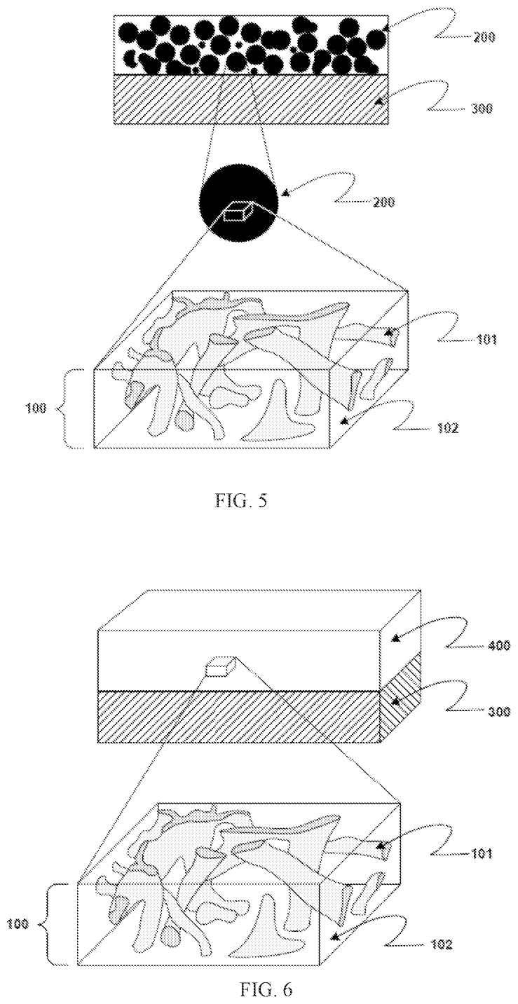

The composite material can be in the form of particles (spheres, rods, etc.), 200. a coating, 400. or a bulk structure. In some embodiments, the material can be deposited on a backing layer, 300, non-limiting examples shown in FIGS. 5 and 6, for particles and for a continuous sheet respectively. In some composite material embodiments, the average size of the particles can range from about 1 nm, about 5 nm, about 10 nm, about 20 nm, about 50 nm, about 75 nm, about 100 nm, about 250 nm, about 500 nm, about 750 nm, about 1 μm, about 20 μm, about 50 μm, about 100 μm, about 250 μm, about 300 μm, about 500 μm, about 750 μm, about 1 mm, about 2 mm, to about 5 mm, or any range combination thereof. The average size is defined as the diameter of a sphere having the same volume as the particle.

In some embodiments, the stiff phase material and the compliant phase material are chosen such that the ratio of Young's Modulus of the stiffest stiff phase to the Young's Modulus of the softest compliant phase can be greater than about 1, but typically can be greater than or equal to about 100. In some embodiments, the ratio of Young's Modulus of the stiff phase to the Young's Modulus of the compliant phase is from about 100 to about 35,000, about 100 to about 4000, about 100 to about 3000. For some coatings, the ratio of Young's Modulus of the particles to the matrix is about 100. While not wanting to be limited by theory it is thought that at high impact strain energies the complaint phase acts similar to a non-Newtonian fluid and instead of deforming (under quasi-static conditions) it is held in place by the stiff phase and concurrently supports the stiff phase while the system is absorbing energy. However, once the force is absorbed the compliant phase can redistribute within the stiff phase, back to equilibrium conditions.

In some composite materials, the stiff phase can have a Young's modulus that can range from about 70 GPa, about 90 GPa, about 120 GPa, about 150 GPa, about 180 GPa. about 210 GPa, about 287 GPa, about 435 GPa, about 450 GPa, about 550 GPa, about 1000 GPa, about 1220 GPa, about 2000 GPa, about 2400 GPa, to about 3500 GPa, or any combination thereof. In some embodiments, the stiff phase can comprise aromatic polyamides (i.e., aramids), ultra-high-molecular-weight polyethylene (UHMWPE), aluminum (e.g., α-Al₂O₃), boron (e.g., boron nitride, cubic boron nitride, boron carbide), silicon (e.g., SiO₂, silicon nitride, silicon carbide), titanium (e.g., titanium nitride, titanium carbide, titanium diboride), tungsten (e.g., tungsten nitride, tungsten carbide), zirconium (e.g., zirconium nitride, zirconium carbide), niobium (e.g., niobium nitride, niobium carbide), vanadium (e.g., vanadium nitride, vanadium carbide), rhenium (e.g., rhenium diboride, rhenium nitride, rhenium carbide), molybdenum (molybdenum carbide, molybdenum nitride, molybdenum boride), iron, diamond, graphene, carbon nanotubes, or fullerene.

With some materials, the compliant phase can have a Young's modulus that can range from about 0.1 MPa, about 1 MPa, about 10 MPa, about 25 MPs, about 50 MPa, about 75 MPa, about 100 MPa, about 1 GPa, about 4 GPa, about 10 GPa, about 20 GPa, about 50 GPa, to about 100 GPa, or any combination thereof, such as about 0.11 GPa, about 0.4 GPa, about 0.45 GPa, about 0.8 GPa, about 1.5 GPa, about 2.0 GPa, about 2.5 GPa, about 2.6 GPa. about 2.7 GPa, about 3 GPa, about 3.5 GPa, about 4 GPa. The compliant phases can comprise biological polymers, synthetic polymers and softer metals. In some compliant phases, the biological polymers can comprise chitin, chitosan, cellulose, lignin, hemicellulose, or proteins (e.g., keratin).

In some embodiments, the compliant phase can comprise a synthetic polymer such as poly-epoxide, polyvinyl alcohol (PVA), low density polyethylene (LDPE), high density polyethylene (HDPE), polycarbonate (PC), polystyrene (PS), polypropylene (PP), polyurethane, polytetrafluoroethylene (PTFE), polyvinyl chloride (PVC), polyamide (Nylon), polyethylene glycol (PEG), polyethylene tcrephthalate (PET), polybutylene terephthalate (PBT), polytrimethylene terephthalate, polyethylene naphthalate, polymethylmethacrylate (PMMA or acrylic), poly-epoxide, polyoxymethylene (POM or acetal), acrylonitrile butadiene styrene (ABS), polyglycolic acid, polylactic acid, polycaprolactone, polyhydroxyalkanoate, polyhydroxybutyrate, polyethylene adipate, polybutylene succinate, or poly(3-hydroxybutyrate-co-3-hydroxyvalerate). In some embodiments, the material matrix can comprise a poly-epoxide, or epoxy.

For some embodiments, the compliant phase can comprise a metal, so long as the Young's Modulus ratio is satisfied, such as lead, gold, silver, tin, zinc, aluminum, thorium, copper, brass or bronze, in the presence of a stiffer stiff-phase material.

For composite materials, the crystallinity of either the stiff phase or compliant phase can be adjusted to tailor the material modulus, hardness, and energy dissipation. While not wanting to be limited by theory, the crystallinity can affect the efficiency of energy dissipation under high-strain rate impacts. During high-strain rate events, dislocation and amorphization will be induced in highly crystalline particles, which are additional energy dissipation mechanisms compared to amorphous or low crystalline materials. In addition, it is thought that the crystalline materials can have interfaces (i.e., low angle grain boundaries) that can be exploited to add energy dissipation via fracture of said interfaces.

For some composite materials, the volume fill fraction of the stiff phase, as measured by volumetric ratio, can vary from about 0.1 vol. %, 0.5 vol. %, 1 vol. %, about 5 vol. %, about 10 vol. %, about 11 vol. %, about 12.5 vol. %, about 20 vol. %, about 25 vol. %, about 30 vol. %, about 40 vol. %, about 50 vol. %, about 60 vol. %, about 70 vol. %, about 75 vol. %, about 80 vol. %, about 90 vol. %, about 95 vol. %, about 99 vol. %, to about 99.9 vol. %, or a combination thereof. For some composite materials, the volume fill fraction of the compliant phase, as measured by volumetric ratio, can vary from about 0.1 vol. %, 0.5 vol. %, 1 vol. %, about 5 vol. %, about 10 vol. %, about 11 vol. %, about 12.5 vol. %. about 20 vol. %, about 25 vol. %, about 30 vol. %, about 40 vol. %, about 50 vol. %, about 60 vol. %, about 70 vol. %, about 75 vol. %, about 80 vol. %, about 90 vol. %, about 95 vol. %, about 99 vol. %, to about 99.9 vol. %, or a combination thereof. In some embodiments the volume fill fraction can be about 10 vol. % stiff phase to about 90 vol. % compliant phase. While not wanting to be limited by theory, the relative concentrations of particles and matrix material can be varied to affect the packing density of phases. While not wanting to be limited by theory, based on the ratio of Young Moduli, the relative packing density of the phases can be optimized to yield in greater impact absorption.

### Methods of Making the Composite Material

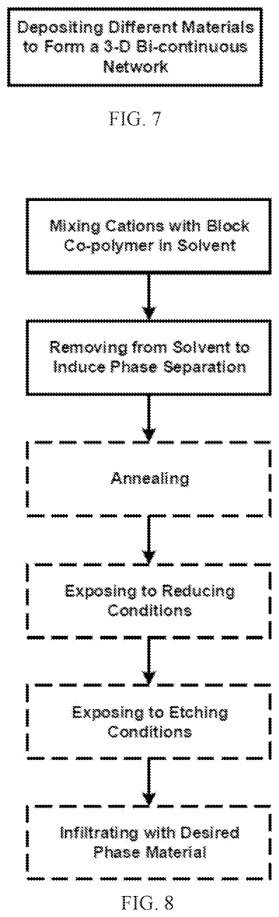

Some embodiments describe a method for making the aforedescribed composite material. A non-limiting example is shown in FIG. 7. In some embodiments, the process can comprise obtaining a backing layer, and then depositing different materials such that a 3-dimensional (3-D) bi-continuous network of a stiff phase and a compliant phase are generated. Depositing can be done by methods known in the art such as 3-D printing (including but not limited to multi-material 3-D printing where different materials can be printed by the printer), selective chemical vapor deposition, sol-gel processing, other solution-based processes, and the like. Other solution-based processes can comprise co-precipitation or hydro/solvothermal methods.

For other method embodiments, the process can comprise creating nanostructures from phase separated polymers, a non-limiting embodiment depicted in FIG. 8. Some methods comprise mixing cations with a block co-polymer in a solvent where one of the domains of the polymer contains moieties that will bind to the cations. When the block co-polymer solutions are removed from the solvent, a phase separation will occur resulting in the formation of bi-continuous networks, e.g., a gyroid phase, within the material. In some embodiments, the method can further comprise the steps of annealing the resulting material, exposing the resulting material to reducing conditions to precipitate the stiff phase, and/or exposing the resulting material to etching conditions, in order to remove one of the phases present in the material. In some embodiments, the phase removed can be non-cation binding portion of the polymer with only the stiff phase remaining. In other methods, the phase removed can be the cation-bound portion of the polymer with only the compliant phase remaining. The result is a separated matrix.

In some methods where a phase was removed, the resulting matrix can be infiltrated with a desired phase material, either compliant or stiff depending on the phase removed. For example, if the non-cation binding portion of the polymer was removed the resulting matrix can be infiltrated with a desired compliant phase material. Also, if the cation-bound portion of the polymer was removed the resulting matrix can be infiltrated with a desired stiff phase material.

In yet other embodiments, where the material properties of the phases are satisfied by the material, the stiff phase can comprise the cation-bound portion of the polymer and the compliant phase can comprise the non-cation portion of the polymer, and the material can be left intact, as is without removal of any phase.

In some methods, annealing can be done at temperatures of between about 50° C., about 70° C. about 80° C., about 85° C., about 90° C., about 95° C. about 100° C. about 150° C., about 200° C., about 220° C., to about 250° C., or any combination thereof, such as about 90° C. for a duration from about 10 minutes, about 20 minutes, about 30 minutes, about 1 hour. about 2 hours, about 3 hours, about 6 hours, about 8 hours, about 12 hours, about 18 hours, to about 24 hours, or any combination thereof.

In some methods, exposing the material to reducing conditions to precipitate the stiff phase, or chemically nucleate cations bound to the portion of the polymer, can comprise exposing to a reductant such as hydrazine or sodium borohydride in a solvent, such as water, ethanol, chloroform, acetone, dioxane, toluene, for a duration from about 0.1 minutes, about 1 minute, about 10 minutes, about 20 minutes, about 30 minutes, about 1 hour, about 2 hours, about 3 hours, about 6 hours, about 8 hours, about 12 hours, about 18 hours, to about 24 hours, or any combination thereof.

In some methods, exposing the material to etching conditions can comprise exposing to a solvent, such as water, ethanol, chloroform, acetone, dioxane, toluene, carbon disulfide, or a combination thereof, for a duration from about 10 minutes, about 20 minutes, about 30 minutes. about 1 hour, about 2 hours, about 3 hours, about 6 hours, about 8 hours, about 12 hours, about 18 hours, to about 24 hours, or any combination thereof. In some embodiments the coated layer can be cured at an atmosphere of about 1 atm. For some methods, the time for curing can range from nearly instantaneously, about 10 seconds, about 30 minutes, about 1 hour, about 2 hours, about 3 hours, about 6 hours, about 12 hours, about 18 hours, to about 24 hours, or any combination thereof.

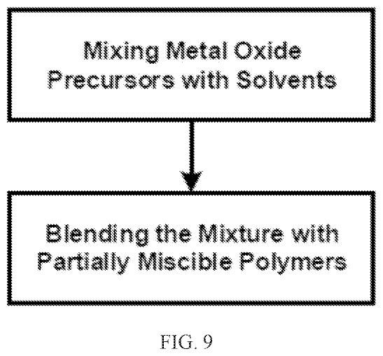

For yet other method embodiments, making the aforedescribed composite material can comprise mixing metal oxide precursors with solvents and then blending the mixture with partially miscible polymers to form phase separated bi-continuous network particles. A non-limiting example is shown in FIG. 9.

Still other embodiments describe a method of making the aforementioned composite material, the method can comprise mixing metal oxide precursors with solvents and blending the mixture with partially miscible polymers to form phase separated bi-continuous network particles.

To better illustrate the devices and methods disclosed herein, a non-limiting list of embodiments is provided here:

Example 1 includes a composite material comprising a plurality of phases, the plurality comprising at least one stiff phase and at least one compliant phase where the stiff phase forms an interpenetrating network within the compliant phase, where the interpenetrating network is described as a bi-continuous phase, where the ratio of bulk moduli of the stiff phase to the compliant phase is greater than 2.

Example 2 includes the composite material of example 1, wherein the ratio of bulk moduli of the stiff phase to the compliant phase is from 100 to 3000.

Example 3 includes the composite material of any one of examples 1-2, wherein the stiff phase comprises aromatic polyamides (i.e., aramids), ultra-high-molecular-weight polyethylene (UHMWPE), aluminum (e.g., α-Al₂O₃), boron (e.g., boron nitride, cubic boron nitride, boron carbide), silicon (e.g., SiO₂, silicon nitride, silicon carbide), titanium (e.g., titanium nitride, titanium carbide, titanium diboride), tungsten (e.g., tungsten nitride, tungsten carbide), zirconium (e.g., zirconium nitride, zirconium carbide), niobium (e.g., niobium nitride, niobium carbide), vanadium (e.g., vanadium nitride, vanadium carbide), rhenium (e.g., rhenium diboride, rhenium nitride, rhenium carbide), molybdenum (molybdenum carbide, molybdenum nitride, molybdenum boride), iron, diamond, graphene, carbon nanotubes, or fullerene.

Example 4 includes the composite material of any one of examples 1-3, wherein the compliant phase comprises chitin, chitosan, cellulose, lignin, hemicellulose, or proteins.

Example 5 includes the composite material of any one of examples 1-4, wherein the compliant phase comprises poly-epoxide, polyvinyl alcohol (PVA), low density polyethylene (LDPE), high density polyethylene (HDPE), polycarbonate (PC), polystyrene (PS), polypropylene (PP), polyurethane, polytetrafluoroethylene (PTFE), polyvinyl chloride (PVC), polyamide (Nylon), polyethylene glycol (PEG), polyethylene terephthalate (PET), polybutylene terephthalate (PBT), polytrimethylene terephthalate, polyethylene naphthalate, polymethylmethacrylate (PMMA or acrylic), poly-epoxide, polyoxymethylene (POM or acetal), acrylonitrile butadiene styrene (ABS), polyglycolic acid, polylactic acid, polycaprolactone, polyhydroxyalkanoate, polyhydroxybutyrate, polyethylene adipate, polybutylene succinate, or poly(3-hydroxybutyrate-co-3-hydroxyvalerate). In some embodiments, the material matrix can comprise a poly-epoxide, or epoxy.

Example 6 includes the composite material of any one of examples 1-5, wherein the compliant phase comprises lead, gold, silver, tin, zinc, aluminum, thorium, copper, brass or bronze.

Example 7 includes the composite material of any one of examples 1-6, wherein a ratio of volume fill fraction of the stiff phase, as measured by volumetric ratio, is from 0.1 vol. % to 99.9 vol. %.

Example 8 includes the composite material of any one of examples 1-7, wherein a ratio of volume fill fraction of the compliant phase, as measured by volumetric ratio, is from 0.1 vol. % to 99.9 vol. %.

Example 9 includes the composite material of any one of examples 1-8, wherein the composite material includes particles coupled together to define one or more of the phases.

Example 10 includes the composite material of any one of examples 1-9, wherein a size of the particles ranges from 1 nm to 5 mm.

Example 11 includes a method of making the composite material of any one of examples 1-10, including depositing different materials such that a 3-D bi-continuous network of a stiff phase and a compliant phase are generated, where the steps of depositing is done by 3-D printing, selective chemical vapor deposition, sol-gel processing, co-precipitation, or hydro/solvothermal methods.

Example 12 includes a method of making the composite material of any one of examples 1-11, including mixing a cation with a block co-polymer in a solvent where one of the domains of the polymer contains moieties that will bind to the cation to form a mixture, removing the mixture from the solvent to form bi-continuous networks in a material.

Example 13 includes a method of making the composite material of any one of examples 1-12, including annealing the mixture to burn off the non-cation binding portion of the polymer to yield a stiff phase and infiltrating the matrix with a compliant phase material.

Example 14 includes a method of making the composite material of any one of examples 1-13, including exposing the mixture to a reducing condition to chemically nucleate cations bound to the portion of the polymer.

Example 15 includes a method of making the composite material of any one of examples 1-14, including exposing the mixture to an etching condition to chemically remove the non-cation binding portion of the polymer to yield a stiff phase and infiltrating the matrix with a compliant phase material.

Example 16 includes a method of making the composite material of any one of examples 1-15, including annealing the mixture to burn off the non-cation binding portion of the polymer to yield a compliant phase and infiltrating the matrix with a stiff phase material.

Example 17 includes a method of making the composite material of any one of examples 1-16, including exposing the mixture to an etching condition to chemically remove the cation-bound portion of the polymer to yield a compliant phase and infiltrating the matrix with a stiff phase material.

Example 18 includes a method of making the composite material of any one of examples 1-17, including mixing metal oxide precursors with solvents and blending the mixture with partially miscible polymers to form phase separated bi-continuous network particles.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The foregoing description, for the purpose of explanation, has been described with reference to specific example embodiments. However, the illustrative discussions above are not intended to be exhaustive or to limit the possible example embodiments to the precise forms disclosed. Many modifications and variations are possible in view of the above teachings. The example embodiments were chosen and described in order to best explain the principles involved and their practical applications, to thereby enable others skilled in the art to best utilize the various example embodiments with various modifications as are suited to the particular use contemplated.

It will also be understood that, although the teens “first,” “second,” and so forth may be used herein to describe various elements, these elements should not be limited by these terms. These terms are only used to distinguish one element from another. For example, a first contact could be termed a second contact, and, similarly, a second contact could be termed a first contact, without departing from the scope of the present example embodiments. The first contact and the second contact are both contacts, but they are not the same contact.

The terminology used in the description of the example embodiments herein is for the purpose of describing particular example embodiments only and is not intended to be limiting. As used in the description of the example embodiments and the appended examples, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

What is claimed is:

1. A composite material comprising a plurality of phases, the plurality comprising at least one stiff phase and at least one compliant phase where the stiff phase and compliant phase are interpenetrating to form an interpenetrating network, and where the interpenetrating network is described as bi-continuous, where the ratio of bulk moduli of the stiff phase to the compliant phase is greater than 2.

2. The material of claim 1, where the ratio of bulk moduli of the stiff phase to the compliant phase is from 100 to 3000.

3. The material of claim 1, where the stiff phase comprises aromatic polyamides (i.e., aramids), ultra-high-molecular-weight polyethylene (UHMWPE), aluminum (e.g., α-Al₂O₃), boron (e.g., boron nitride, cubic boron nitride, boron carbide), silicon (e.g., SiO₂, silicon nitride, silicon carbide), titanium (e.g., titanium nitride, titanium carbide, titanium diboride), tungsten (e.g., tungsten nitride, tungsten carbide), zirconium (e.g., zirconium nitride, zirconium carbide), niobium (e.g., niobium nitride, niobium carbide), vanadium (e.g., vanadium nitride, vanadium carbide), rhenium (e.g., rhenium diboride, rhenium nitride, rhenium carbide), molybdenum (molybdenum carbide, molybdenum nitride, molybdenum boride), iron, diamond, graphene, carbon nanotubes, or fullerene.

4. The material of claim 1, where the compliant phase comprises chitin, chitosan, cellulose, lignin, hemicellulose, or proteins.

5. The material of claim 1, where the compliant phase comprises poly-epoxide, polyvinyl alcohol (PVA), low density polyethylene (LDPE), high density polyethylene (HDPE), polycarbonate (PC), polystyrene (PS), polypropylene (PP), polyurethane, polytetrafluomethylene (PTFE), polyvinyl chloride (PVC), polyamide (Nylon), polyethylene glycol (PEG), polyethylene terephthalate (PET), polybutylene terephthalate (PBT), polytrimethylene terephthalate, polyethylene naphthalate, polymethylmethacrylate (PMMA or acrylic), poly-epoxide, polyoxymethylene (POM or acetal), acrylonitrile butadiene styrene (ABS), polyglycolic acid, polylactic acid, polycaprolactone, polyhydroxyalkanoate, polyhydroxybutyrate, polyethylene adipate, polybutylene succinate, or poly(3-hydroxybutyrate-co-3-hydroxyvalerate). In some embodiments, the material matrix can comprise a poly-epoxide, or epoxy.

6. The material of claim 1, where the compliant phase comprises lead, gold, silver, tin, zinc, aluminum, thorium, copper, brass or bronze.

7. A method of making the composite material of claim 1, the method comprising: depositing different materials such that a 3-D bi-continuous network of a stiff phase and a compliant phase are generated, where the steps of depositing is done by 3-D printing, selective chemical vapor deposition, sol-gel processing, co-precipitation, or hydro/solvothermal methods.

8. A method of making the composite material of claim 1, the method comprising: mixing a cation with a block co-polymer in a solvent where one of the domains of the polymer contains moieties that will bind to the cation to form a mixture, removing the mixture from the solvent to form bi-continuous networks in a material.

9. The method of claim 8, further comprising: annealing the mixture to burn off the non-cation binding portion of the polymer to yield a stiff phase and infiltrating the matrix with a compliant phase material.

10. The method of claim 8, further comprising: exposing the mixture to a reducing condition to chemically nucleate cations bound to the portion of the polymer.

11. The method of claim 8, further comprising: exposing the mixture to an etching condition to chemically remove the non-cation binding portion of the polymer to yield a stiff phase and infiltrating the matrix with a compliant phase material.

12. The method of claim 8, further comprising: annealing the mixture to burn off the non-cation binding portion of the polymer to yield a compliant phase and infiltrating the matrix with a stiff phase material.

13. The method of claim 8, further comprising: exposing the mixture to an etching condition to chemically remove the cation-bound portion of the polymer to yield a compliant phase and infiltrating the matrix with a stiff phase material.

14. A method of making the composite material of claim 1, the method comprising mixing metal oxide precursors with solvents and blending the mixture with partially miscible polymers to form phase separated bi-continuous network particles.

15. A composite material, comprising:
a first hydroxyapatite (HAP) phase, and
a second polymer phase;
wherein the first phase and the second phase are substantially bi-continuous in microstructure.
